(19) United States
(12) Patent Application Publication
(10) Pub. No.: US 2026/0267093 A1
(43) Pub. Date: Sep. 10, 2026

(54) SEMICONDUCTOR PHOTONICS SYSTEM AND METHODS OF MANUFACTURING

(71) Applicants: Taiwan Semiconductor Manufacturing Company, Ltd., Hsinchu (TW); TSMC Arizona Corporation, Phoenix, AZ (US)

(72) Inventors: Ali DAVOODABADI, Phoenix, AZ (US); Xuewen TANG, Gilbert, AZ (US); Wen-Hsien CHUANG, Taipei City (TW)

(21) Appl. No.: 19/073,985

(22) Filed: Mar. 7, 2025

(51) Int. Cl. G02B 6/42

(52) U.S. Cl. CPC G02B 6/423; G02B 6/4243

(57) ABSTRACT

A photonic alignment device, for use in a semiconductor photonics system, may include a combination of alignment grooves and alignment guides to provide a highly reliable and repeatable mechanism for aligning a photonic integrated circuit device, an optical interconnect structure, and an optical fiber. The photonics alignment device may increase manufacturing throughput of semiconductor photonics systems in that the photonics alignment device enables alignment of the optical fiber and optical interconnect structure to be achieved in an expedient matter without having to strip the cladding from around the end of the fiber core for optically coupling the optical fiber to the optical interconnect structure (which eliminates a time-consuming processing operation in the manufacturing of semiconductor photonics systems).

### BACKGROUND

A photonic integrated circuit device is a type of semiconductor device that includes one or more photonic integrated circuits. A photonic integrated circuit may be configured to use optical signals for high speed and secure data transmission. A photonic integrated circuit may include various photonics components, such as optical waveguides, photodetectors, optical resonators, grating couplers, and/or optical modulators, among other examples.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C are diagrams of an example semiconductor photonics system described herein.

FIG. 2 is a diagram of an example implementation of optical signal propagation in the semiconductor photonics system described herein.

FIG. 3 is a diagram of an example implementation of a portion of the semiconductor photonics system described herein.

FIG. 4 is a diagram of an example implementation of a portion of the semiconductor photonics system described herein.

FIG. 5 is a diagram of an example implementation of an optical interconnect structure of the semiconductor photonics system described herein.

FIGS. 6A-6G are diagrams of an example implementation of forming an upper alignment structure of a photonics alignment device of the semiconductor photonics system described herein.

FIGS. 7A and 7B are diagrams of an example implementation of forming a lower alignment structure of the photonics alignment device described herein.

FIGS. 8A-8E are diagrams of an example implementation of forming the optical interconnect structure described herein.

FIGS. 9A-9C are diagrams of an example implementation of forming a photonic integrated circuit device of the semiconductor photonics system described herein.

FIGS. 10A-10D are diagrams of an example implementation of assembling the semiconductor photonics system described herein.

FIG. 11 is a flowchart of an example process associated with forming the semiconductor photonics system.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A grating coupler of a photonic integrated circuit device may be configured to receive an input optical signal from an optical fiber and direct the optical signal toward one or more photonics components of a photonic integrated circuit of the photonic integrated circuit device. The optical coupling efficiency between the optical fiber and the grating coupler may be dependent upon the alignment of the optical fiber and an optical interconnect that couples the optical signal from the optical fiber to the grating coupler. If misalignment occurs, an increased amount of optical loss (which may be referred to as insertion loss) may be experienced, which may result in data loss, reduced reliability, and/or increased power consumption.

In some implementations described herein, a photonics alignment device is included in a semiconductor photonics system that includes a photonic integrated circuit device and an optical interconnect structure to increase the accuracy and repeatability of alignment of the optical fiber and the optical interconnect structure. For example, the photonics alignment device may include a lower alignment structure and an upper alignment structure that is configured to be removably coupled to the lower alignment structure to secure the optical fiber between the lower alignment structure and the upper alignment structure without having to strip the cladding from the fiber core of the optical fiber to optically couple the optical fiber to the optical interconnect structure. Instead, the upper alignment structure may include an alignment groove in which the cladding and fiber core of the optical fiber are secured between the upper alignment structure and the lower alignment structure so that the end of the fiber core facing the optical interconnect structure is spaced apart from the optical interconnect structure by an airgap. The upper alignment structure may also include another alignment groove that is to be placed over the optical interconnect structure to align the optical interconnect structure and the optical fiber. The size (e.g., the length) of the airgap may be reliably and repeatably achieved through the inclusion of a lateral alignment step in the upper alignment structure between the alignment grooves for the optical fiber and the optical interconnect structure. The upper alignment structure of the photonics alignment device, and the optical interconnect structure, may each include one or more alignment guides that interface with alignment grooves on the photonic integrated circuit device to align the optical interconnect structure and the photonics alignment device with the photonic integrated circuit device.

The combination of alignment grooves and alignment guides described above provides a highly reliable and repeatable mechanism for aligning the photonic integrated circuit device, the optical interconnect structure, and the optical fiber. The photonics alignment device may increase manufacturing throughput of semiconductor photonics systems in that the photonics alignment device enables alignment of the optical fiber and optical interconnect structure to be achieved in an expedient matter without having to strip the cladding from around the end of the fiber core for optically coupling the optical fiber to the optical interconnect structure (which eliminates a time-consuming processing operation in the manufacturing of semiconductor photonics systems).

To provide some adjustability in the alignment of the end of the fiber core and the optical interconnect structure, the optical interconnect structure may include a microlens structure facing the end of the fiber core. The microlens structure may be configured to collimate and focus optical signals toward a reflection surface of the optical interconnect structure that directs the optical signals from the microlens structure toward a grating coupler of the photonic integrated circuit device, which may provide for increased tolerance in variation in the alignment between the end of the fiber core and the optical interconnect structure.

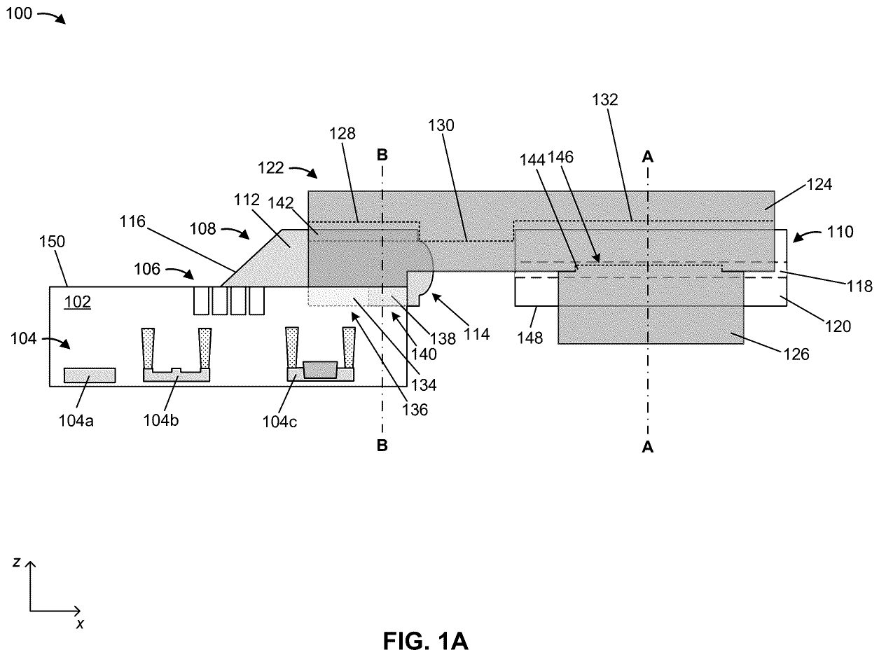

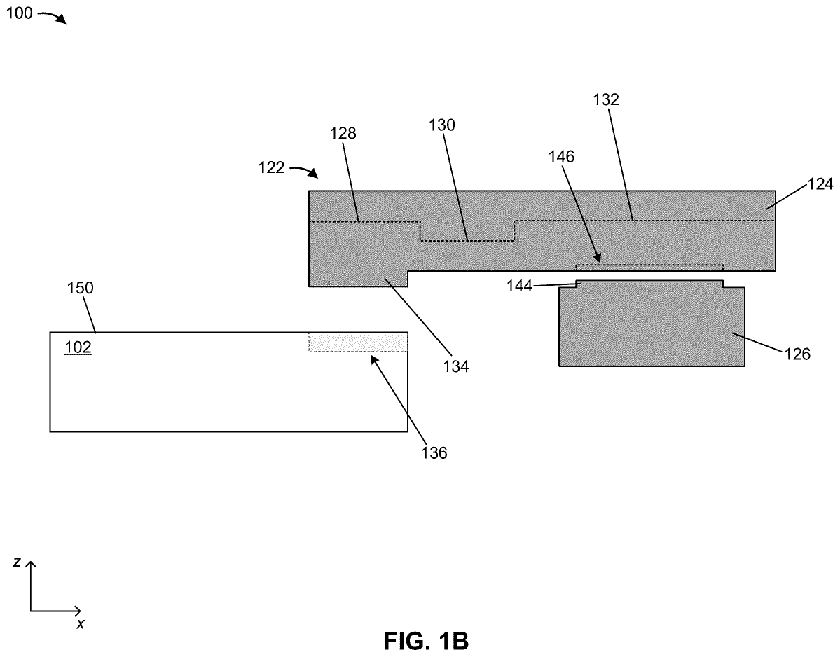

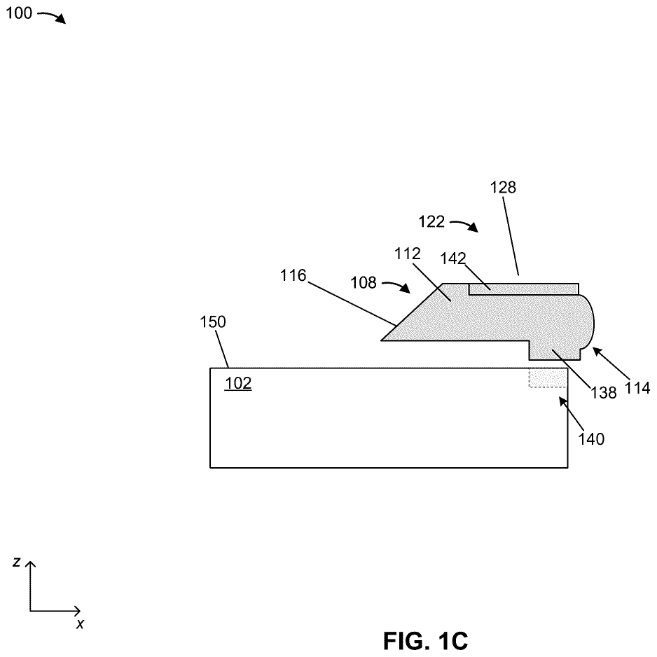

FIGS. 1A-1C are diagrams of an example semiconductor photonics system 100 described herein. FIG. 1A illustrates a side view of the semiconductor photonics system 100. FIG. 1B illustrates an exploded view of a subset of the components of the semiconductor photonics system 100. FIG. 1C illustrates another exploded view of another subset of the components of the semiconductor photonics system 100.

As shown in FIG. 1A, the semiconductor photonics system 100 includes a photonic integrated circuit device 102 that includes one or more photonic integrated circuits 104. In some implementations, the photonic integrated circuit device 102 is co-packaged with one or more electrical integrated circuits.

A photonic integrated circuit 104 of the photonic integrated circuit device 102 may be configured to transmit, receive, and/or process optical signals. In some implementations, the optical signals are single-mode optical signals, multiple-mode optical signals, and/or a combination thereof. In some implementations, a photonic integrated circuit 104 may be configured to convert between electrical signals and optical signals for high-bandwidth optical communications.

A photonic integrated circuit 104 of the photonic integrated circuit device 102 may include one or more photonics components, such as an optical waveguide 104a, an optical modulator 104b, and/or a photodetector 104c, among other examples.

An optical waveguide 104a of the photonic integrated circuit 104 may include a semiconductor waveguide, a dielectric waveguide, a combination thereof, and/or another type of optical waveguide that enables confinement of optical signals to reduce optical loss and increase propagation efficiency for the optical signals. An optical waveguide 104a may have a slab waveguide structure, a ridge waveguide structure, a rib waveguide structure, and/or another type of optical waveguide structure.

An optical modulator 104b of the photonic integrated circuit 104 may be configured to receive an optical signal and encode data onto the optical signal by modulating the optical signal. The optical modulator 104b may modulate the phase of the optical signal and/or another attribute of the optical signal. An optical modulator 104b may be a Mach-Zehnder modulator, a micro-ring modulator, and/or another type of optical modulator.

A photodetector 104c of the photonic integrated circuit 104 may be configured to generate a current, a voltage, and/or another type of electrical output signal based on absorbed photons of light from an optical signal. A photodetector 104c may include a semiconductor absorption region that converts photons to electrodes, and a semiconductor base that includes terminals that correspond to collection regions for the electrons generated by the absorption region.

A photonic integrated circuit 104 of the photonic integrated circuit device 102 may receive optical signals from a grating coupler 106 of the photonic integrated circuit device 102. The grating coupler 106 may direct optical signals from an optical interconnect structure 108 of the semiconductor photonics system 100 toward the photonic integrated circuit 104. The grating coupler 106 may include a semiconductor structure (e.g., a silicon (Si) structure and/or other types of semiconductor structure) that is configured to diffract the optical signals from an off-plane direction (e.g., an x-direction) in the semiconductor photonics system 100 to an in-plane direction (e.g., a z-direction) that is in the plane of the photonic integrated circuit 104. The grating coupler 106 may include a plurality of periodic gratings. The periodicity of the periodic gratings may be selected to achieve diffraction of one or more wavelengths of the optical signals. In some implementations, the periodicity of the periodic gratings may be selected based on the wavelength of the optical signals.

The optical interconnect structure 108 may be configured to direct the optical signals from an optical fiber 110 toward the photonic integrated circuit 104 of the photonic integrated circuit device 102. The optical interconnect structure 108 and the optical fiber 110 may be substantially aligned in multiple directions, including the y-direction and the z-direction, to facilitate efficient and low-loss propagation of optical signals from the optical fiber 110 to the optical interconnect structure 108.

The optical interconnect structure 108 may include a body 112 that is formed of optically transparent (or optically semi-transparent) material to facilitate the propagation of optical signals through the optical interconnect structure 108. For example, the body 112 of the optical interconnect structure 108 may be formed of silicon (Si), silicon dioxide (SiO₂), and/or another suitable material.

A microlens structure 114 may be coupled to the body 112 of the optical interconnect structure 108. The microlens structure 114 may be an optical lens that is oriented toward the optical fiber 110 (e.g., so that the microlens structure 114 and the optical fiber 110 are facing each other). The microlens structure 114 may be included in order to focus and/or collimate optical signals that propagate from the optical fiber 110 to the optical interconnect structure 108 to compensate or counteract divergence of the optical signals. The microlens structure 114 may be configured to focus the optical signals toward a reflection surface 116 of the optical interconnect structure 108. The reflection surface 116 may be an angled surface of the optical interconnect structure 108 that is angled to redirect the optical signals from the x-direction to the z-direction (or to another direction) toward the grating coupler 106. In some implementations, at least a portion of the body 112 (e.g., a portion that includes the reflection surface 116) may be positioned over at least a portion of the grating coupler 106 to achieve low-loss optical coupling of optical signals between the grating coupler 106 and the optical interconnect structure 108.

The optical fiber 110 may include a fiber core 118 and a cladding 120 around the fiber core 118. The fiber core 118 may be formed of an optically transparent material. In some implementations, the material of the fiber core 118 is silicon dioxide (SiO₂), optical-grade plastic, and/or another suitable material for carrying optical signals. The cladding 120 may be included around the fiber core 118 to protect the fiber core 118 from damage, and/or to increase the optical confinement of optical signals propagating through the optical fiber 110. For example, the fiber core 118 may be formed of a high refractive index material, the cladding may be formed of a low refractive index material, and the difference in the refractive indexes of the fiber core 118 and the cladding 120 may promote reflection of the optical signals for increase optical confinement.

To facilitate fast and accurate alignment of the optical interconnect structure 108 and the fiber core 118, the semiconductor photonics system 100 includes a photonics alignment device 122. The shape and/or components of the photonics alignment device 122 are configured to achieve repeatable relative positioning of the optical interconnect structure 108 and the fiber core 118 (as well as of the photonic integrated circuit device 102 and the optical interconnect structure 108).

As shown in FIG. 1A, the photonics alignment device 122 includes an upper alignment structure 124 and a lower alignment structure 126. The upper alignment structure 124 and the lower alignment structure 126 may be configured to be removably coupled together to position and secure the optical fiber 110. The upper alignment structure 124 may also be configured to be removably coupled to the photonic integrated circuit device 102 to position and secure the optical interconnect structure 108.

The upper alignment structure 124 may include an alignment groove 128 that extends along a portion of the optical interconnect structure 108 (e.g., in the x-direction). The optical interconnect structure 108 may be positioned in the alignment groove 128 so that the optical interconnect structure 108 is positioned and secured between the upper alignment structure 124 and the photonic integrated circuit device 102.

The upper alignment structure 124 may also include a lateral alignment step 130 that is located laterally between the alignment groove 128 and another alignment groove 132 (e.g., in the x-direction). The alignment groove 132 extends along a portion of the optical fiber 110 (e.g., in the x-direction). The optical fiber 110 may be positioned in the alignment groove 132 so that the optical fiber 110 is positioned and secured between the upper alignment structure 124 and the lower alignment structure 126.

The lateral alignment step 130 includes a non-grooved section of the upper alignment structure 124 laterally between the alignment groove 128 and the alignment groove 132 (e.g., in the x-direction). The lateral alignment step 130 may be included to define and span across a fixed-length gap between the microlens structure 114 of the optical interconnect structure 108 and an end (or face) of the fiber core 118 of the optical fiber 110 facing the microlens structure 114. The lateral alignment step 130 enables the desired length of the gap to be quickly and reliably achieved, in that the lateral alignment step 130 may define the lateral (e.g., x-direction) position of the microlens structure 114 and the lateral (e.g., x-direction) position of the end of the fiber core 118 of the optical fiber 110.

To facilitate alignment between the photonic integrated circuit device 102 and the photonics alignment device 122, the upper alignment structure 124 may include one or more alignment guides 134 at the bottom of the upper alignment structure 124. An alignment guide 134 may include a pin, a pillar, a column, a footing, a rectangular prism, a triangular prism, a half cylinder prism, and/or other structure that interfaces with a corresponding alignment groove 136 in the photonic integrated circuit device 102. The alignment groove 136 may be sized and shaped to enable the alignment guide 134 to be fitted into the alignment groove 136 to facilitate lateral alignment (e.g., x-direction and/or y-direction) of the photonic integrated circuit device 102 and the upper alignment structure 124 of the photonics alignment device 122.

Similarly, the optical interconnect structure 108 may include one or more alignment guides 138 at the bottom of the optical interconnect structure 108 to facilitate alignment between the photonic integrated circuit device 102 and the optical interconnect structure 108. An alignment guide 138 may include a pin, a pillar, a column, a footing, a rectangular prism, a triangular prism, a half cylinder prism, and/or other structure that interfaces with a corresponding alignment groove 140 in the photonic integrated circuit device 102. The alignment groove 140 may be sized and shaped to enable the alignment guide 138 to be fitted into the alignment groove 140 to facilitate lateral (e.g., x-direction and/or y-direction) alignment of the photonic integrated circuit device 102 and the optical interconnect structure 108.

At the top of the optical interconnect structure 108, the optical interconnect structure 108 may include one or more alignment guides 142 to facilitate alignment between the optical interconnect structure 108 and the upper alignment structure 124 of the photonics alignment device 122. An alignment guide 142 may include a pin, a pillar, a column, a footing, a rectangular prism, a triangular prism, a half cylinder prism, and/or other structure that interfaces with a corresponding alignment groove 128 in the upper alignment structure 124. The alignment groove 128 may be sized and shaped to enable the alignment guide 142 to be fitted into the alignment groove 128 to facilitate lateral alignment (e.g., x-direction and/or y-direction) of the optical interconnect structure 108 and the upper alignment structure 124.

For positioning and securing the optical fiber 110, the lower alignment structure 126 of the photonics alignment device 122 may include one or more alignment guides 144 to facilitate alignment between the upper alignment structure 124 and the lower alignment structure 126 of the photonics alignment device 122. An alignment guide 144 may include a pin, a pillar, a column, a footing, a rectangular prism, a triangular prism, a half cylinder prism, and/or other structure that interfaces with a corresponding alignment groove 146 in the upper alignment structure 124. The alignment groove 146 may be sized and shaped to enable the alignment guide 144 to be fitted into the alignment groove 146 to facilitate lateral alignment (e.g., x-direction and/or y-direction) of the upper alignment structure 124 and the lower alignment structure 126 of the photonics alignment device 122.

The lower alignment structure 126 may be configured to be positioned such that a bottom surface 148 of the optical fiber 110 is lower in the semiconductor photonics system 100 than a top surface 150 of the photonic integrated circuit device 102. This promotes compactness of the size of the semiconductor photonics system 100 without having to remove the cladding 120 from the optical fiber 110.

As shown in FIG. 1B, the alignment guide 134 at the bottom of the upper alignment structure 124 of the photonics alignment device 122 and the alignment groove 136 in the top surface 150 of the photonic integrated circuit device 102 may both extend in the x-direction. Similarly, the alignment guide 144 at the top of the lower alignment structure 126 of the photonics alignment device 122 and the alignment groove 146 at the bottom of the upper alignment structure 124 may both extend in the x-direction. The alignment guide 134 may be located below the alignment groove 128 in the z-direction, and/or the alignment groove 146 may be located below the alignment groove 132 in the z-direction.

As shown in FIG. 1C, the alignment guide 138 at the bottom of the optical interconnect structure 108 and the alignment groove 140 in the top surface 150 of the photonic integrated circuit device 102 may both extend in the x-direction. The z-direction height of the alignment guide 138 and the z-direction depth of the alignment groove 140 may both be sized such that the bottom surface of the optical interconnect structure 108 rests flatly on the top surface 150 of the photonic integrated circuit device 102. The alignment guide 138 may be located below the alignment guide 142 in the z-direction.

As indicated above, FIGS. 1A-1C are provided as an example. Other examples may differ from what is described with regard to FIGS. 1A-1C.

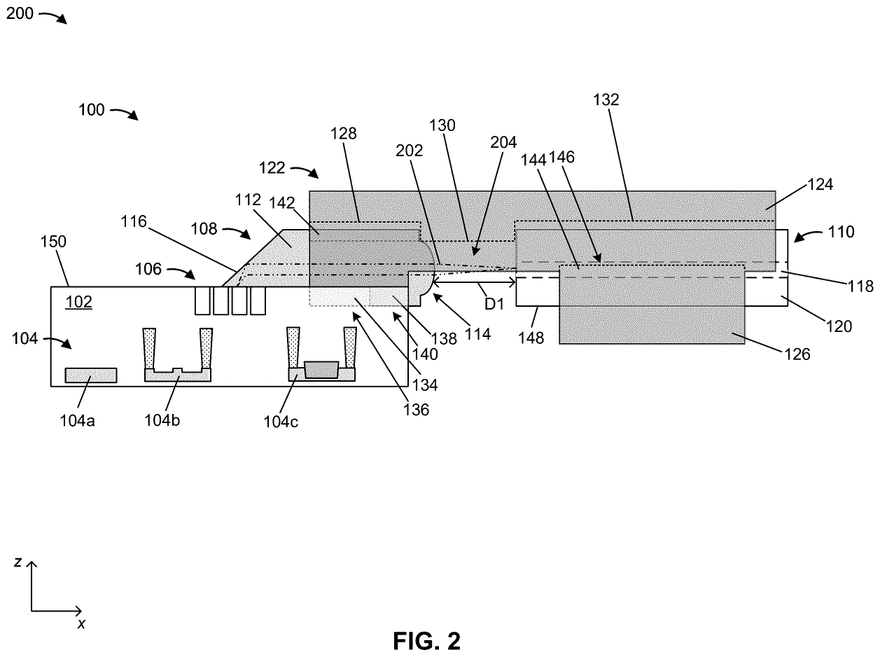

FIG. 2 is a diagram of an example implementation 200 of optical signal propagation in the semiconductor photonics system 100 described herein. The example implementation 200 includes an example of optical signal propagation from the optical fiber 110 to the photonic integrated circuit 104 of the photonic integrated circuit device 102 through the optical interconnect structure 108 after alignment of the photonic integrated circuit device 102, the optical interconnect structure 108, and the optical fiber 110 using the photonics alignment device 122 described herein.

As shown in FIG. 2, an optical signal 202 may propagate from the optical fiber 110 (e.g., primarily in the x-direction) across an airgap 204 to a microlens structure 114 of the optical interconnect structure 108. The microlens structure 114 may receive the optical signal 202 and may collimate the optical signal 202 to counteract divergence of the optical signal 202, and to focus the optical signal 202 toward the reflection surface 116 of the optical interconnect structure 108.

The optical signal 202 may propagate through the body 112 of the optical interconnect structure 108 from the microlens structure 114 to the reflection surface 116. The reflection surface 116 may redirect the optical signal 202 in the z-direction toward the grating coupler 106 of the photonic integrated circuit device 102. The grating coupler 106 may direct the optical signal 202 toward the photonics components of the photonic integrated circuit 104 of the photonic integrated circuit device 102.

In this way, the upper alignment structure 124 may include an embedded step (e.g., the lateral alignment step 130) with alignment grooves 128 and 132 for precise control of beam expansion of the optical signal 202 across a fixed-length airgap 204. The lateral alignment step 130 is embedded to set and maintain a desired airgap length corresponding to a distance between the microlens structure 114 and the end of the fiber core 118 (indicated in FIG. 2 as dimension D1). The length of the airgap 204 may be selected for optimal beam expansion so that a particular final signal mode diameter for the optical signal 202 can be achieved. In some implementations, the length of the airgap 204 is included in a range of approximately 10 microns to approximately 1000 microns and depends on whether single-mode operation or multiple-mode operation is used in the semiconductor photonics system 100. However, other values and ranges are within the scope of the present disclosure.

The microlens structure 114 of the optical interconnect structure 108 enables high optical efficiency and low optical signal loss to be achieved in the semiconductor photonics system 100 through beam expansion and collimation while increasing the alignment tolerance of the semiconductor photonics system 100.

As indicated above, FIG. 2 is provided as an example. Other examples may differ from what is described with regard to FIG. 2.

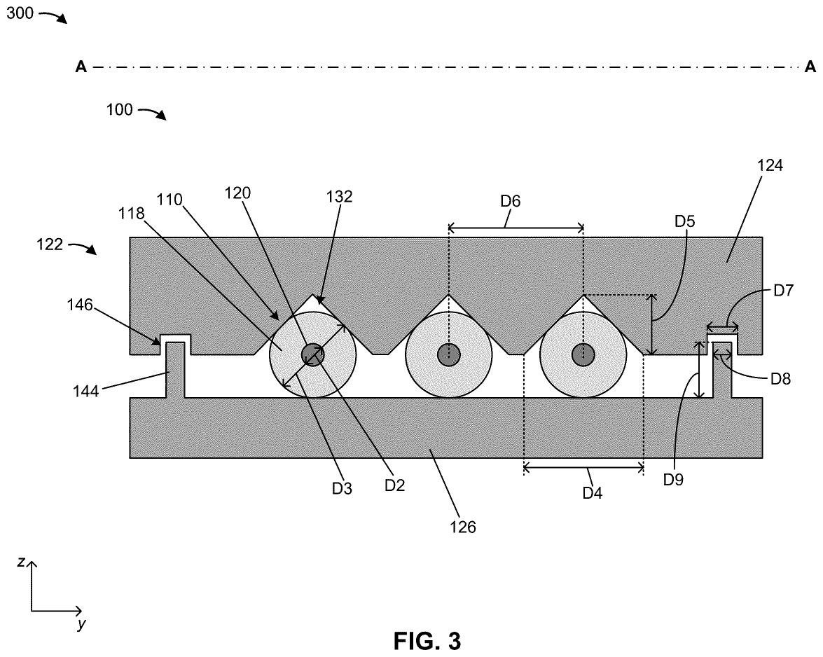

FIG. 3 is a diagram of an example implementation 300 of a portion of the semiconductor photonics system 100 described herein. The portion of the semiconductor photonics system 100 illustrated in FIG. 3 corresponds to a portion of the upper alignment structure 124 of the photonics alignment device 122, a portion of the lower alignment structure 126 of the photonics alignment device 122, and portions of one or more optical fibers 110. FIG. 3 illustrates a cross-section view of the portion of the semiconductor photonics system 100 along the line A-A in FIG. 1A.

As shown in FIG. 3, one or more optical fibers 110 may be secured between the upper alignment structure 124 and the lower alignment structure 126 of the photonics alignment device 122. In implementations in which the semiconductor photonics system 100 includes a plurality of optical fibers 110, the upper alignment structure 124 may include a plurality of corresponding alignment grooves 132. Each alignment groove 132 may be configured to receive and secure a respective optical fiber 110. An alignment groove 132 may be fitted around a corresponding optical fiber 110 so that the optical fiber 110 is secured in the alignment groove 132 by compression force applied by the upper alignment structure 124 and the lower alignment structure 126. Moreover, the alignment grooves 132 may be spaced apart from each other so that the corresponding optical fibers 110 are also spaced apart and are not touching. While the example implementation 300 in FIG. 3 illustrates three optical fibers 110 being included in the semiconductor photonics system 100, other quantities of optical fibers 110 are within the scope of the present disclosure.

As shown in FIG. 3, the alignment grooves 132 may have a V-shaped cross-sectional profile. However, other cross-sectional profiles for the alignment grooves 132 are within the scope of the present disclosure, including U-shaped, square-shaped, and/or rectangular shaped, among other examples.

An alignment groove 132 may be sized to accommodate the fiber core 118 and the cladding 120 of a corresponding optical fiber 110 (e.g., without removing the cladding 120 of the optical fiber 110). A fiber core 118 of an optical fiber 110 may have a diameter (indicated in FIG. 3 as dimension D2) that is included in a range of approximately 6 microns to approximately 12 microns for single-mode operation, or that is included in a range of approximately 20 microns to approximately 70 microns for multiple-mode operation. However, other values and ranges are within the scope of the present disclosure.

An optical fiber 110 may have a diameter (indicated in FIG. 3 as dimension D3) that is included in a range of approximately 75 microns to approximately 150 microns. However, other values and ranges are within the scope of the present disclosure. The lateral (y-direction) width (indicated in FIG. 3 as dimension D4) of a corresponding alignment groove 132 configured to receive the optical fiber 110 may be greater than the diameter of the optical fiber 110 (e.g., D4>D3) so that the optical fiber 110 fits into the alignment groove 132. In some implementations, the vertical (z-direction) height (indicated in FIG. 3 as dimension D5) of the alignment groove 132 is approximately equal to or greater than the radius of the optical fiber 110. In some implementations, the vertical (z-direction) height of the alignment groove 132 is less than the radius of the optical fiber 110.

As indicated above, the alignment grooves 132 may be arranged in the y-direction so that the corresponding optical fibers 110 are spaced apart in the y-direction. The distance between approximate centers of adjacent alignment grooves 132 in the y-direction may be included in a range of approximately 60 microns to approximately 250 microns to minimize interference between adjacent optical fibers 110 while maintaining a relatively small lateral footprint for the semiconductor photonics system. However, other values and ranges are within the scope of the present disclosure.

As further shown in FIG. 3, alignment guides 144 may be located on laterally opposing sides of the alignment grooves 132 in the y-direction. The corresponding alignment grooves 146 may also be located on laterally opposing sides of the alignment grooves 132 in the y-direction so that the alignment guides 144 may be inserted into the alignment grooves 146. The lateral (y-direction) width of an alignment groove 146 (indicated in FIG. 3 as dimension D7) may be greater than the lateral (y-direction) width of a corresponding alignment guide 144 (indicated in FIG. 3 as dimension D8) to provide for some amount of lateral (y-direction) adjustment in the alignment of the upper alignment structure 124 and the lower alignment structure 126. The z-direction height (indicated in FIG. 3 as dimension D9) of the alignment guides 144 may be sized to enable some amount of compression force to be applied to the optical fibers 110 by the upper alignment structure 124 and the lower alignment structure 126 without damaging the optical fibers 110 by compression.

As indicated above, FIG. 3 is provided as an example. Other examples may differ from what is described with regard to FIG. 3.

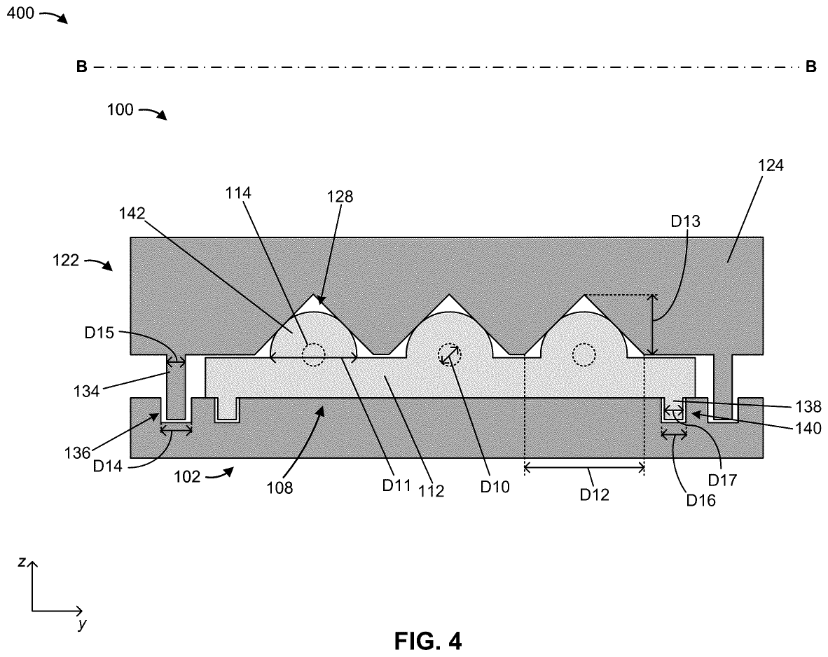

FIG. 4 is a diagram of an example implementation 400 of a portion of the semiconductor photonics system 100 described herein. The portion of the semiconductor photonics system 100 illustrated in FIG. 4 corresponds to a portion of the upper alignment structure 124 of the photonics alignment device 122, a portion of the photonic integrated circuit device 102, and a portion of the optical interconnect structure 108. FIG. 4 illustrates a cross-section view of the portion of the semiconductor photonics system 100 along the line B-B in FIG. 1A.

As shown in FIG. 4, the optical interconnect structure 108 may include one or more alignment guides 142 that extend from the body 112 and that may be secured between the upper alignment structure 124 and the photonics integrated circuit device 102. In implementations in which the optical interconnect structure 108 includes a plurality of optical fibers 110, the optical interconnect structure 108 may include a plurality of corresponding microlens structures 114 that are aligned by corresponding alignment guides 142. The upper alignment structure 124 may include a plurality of corresponding alignment grooves 128, and each alignment groove 128 may be configured to receive and secure a respective alignment guide 142 of the optical interconnect structure 108.

An alignment groove 128 may be fitted around a corresponding alignment guide 142 so that the alignment guide 142 is secured in the alignment groove 128 by compression force applied by the upper alignment structure 124 and the photonics integrated circuit device 102. Moreover, the alignment grooves 128 may be spaced apart from each other so that the corresponding microlens structures 114 are also spaced apart so that optical signals received by the microlens structures 114 do not interfere with each other.

While the example implementation 400 in FIG. 4 illustrates three microlens structures 114 being included in the optical interconnect structure 108, other quantities of microlens structures 114 are within the scope of the present disclosure.

In some implementations, the quantity of alignment guides 142 and the quantity of alignment grooves 128 are different quantities. For example, the optical interconnect structure 108 may include a lesser quantity of alignment guides 142 than the quantity of alignment grooves 128 included in the upper alignment structure 124. In these implementations, one or more of the alignment grooves 128 are empty (e.g., not filled in by a corresponding alignment guide 142. The quantity of alignment grooves 128 included in the upper alignment structure 124 provides for flexibility in different configurations of optical interconnect structures 108 that can be used with the upper alignment structure 124. In particular, the upper alignment structure 124 can be used with optical interconnect structures 108 that have quantities of alignment guides 142 that are equal to or less than the quantity of alignment grooves 128 of the upper alignment structure 124.

As shown in FIG. 4, the alignment grooves 128 may have a V-shaped cross-sectional profile. However, other cross-sectional profiles for the alignment grooves 128 are within the scope of the present disclosure, including U-shaped, square-shaped, and/or rectangular shaped, among other examples. The alignment guides 142 may have a semi-circular cross-sectional profile or another cross-sectional profile, including U-shaped, square-shaped, and/or rectangular shaped, among other examples.

As further shown in FIG. 4, a microlens structure 114 may have a cross-sectional diameter (e.g., in the y-direction, approximately perpendicular to the direction of optical signal propagation) indicated in FIG. 4 as dimension D10. The cross-sectional diameter of a microlens structure 114 may be greater than a cross-sectional diameter of a fiber core 118 of a corresponding optical fiber 110 from which the microlens structure 114 is to receive optical signals. The greater cross-sectional diameter of the microlens structure 114 accounts for beam divergence of the optical signals so that low insertion loss can be achieved. In some implementations, the cross-sectional diameter of a microlens structure 114 is greater than approximately 6 microns and less than approximately 500 microns for single-mode operation and/or for multiple-mode operation. However, other values and ranges are within the scope of the present disclosure.

An alignment groove 128 may be sized to accommodate the lateral (y-direction) width of a corresponding alignment guide 142 (indicated in FIG. 4 as dimension D11). For example, the lateral (y-direction) width (indicated in FIG. 4 as dimension D12) of an alignment groove 128 may be greater than the lateral (y-direction) width of a corresponding alignment guide 142 (e.g., D12>D11) so that the alignment guide 142 fits into the alignment groove 128. In some implementations, the vertical (z-direction) height (indicated in FIG. 4 as dimension D13) of the alignment groove 128 is approximately equal to or greater than the radius of the alignment guide 142. In some implementations, the vertical (z-direction) height of the alignment groove 128 is less than the radius of the alignment guide 142.

As further shown in FIG. 4, the alignment guides 134 may be located on laterally opposing sides of the alignment grooves 128 in the y-direction. The corresponding alignment grooves 136 may also be located on laterally opposing sides of the alignment grooves 128 in the y-direction so that the alignment guides 134 may be inserted into the alignment grooves 136. The alignment guides 134 may extend alongside the sides of the body 112 of the optical interconnect structure 108.

As further shown in FIG. 4, the alignment guides 138 may be located on laterally opposing sides of the alignment guides 142 in the y-direction. The corresponding alignment grooves 140 may also be located on laterally opposing sides of the alignment guides 142 in the y-direction so that the alignment guides 138 may be inserted into the alignment grooves 140. The alignment grooves 136 may be located laterally adjacent to the alignment grooves 140 in the y-direction. The alignment guides 138 may be located laterally adjacent to the alignment guides 134 in the y-direction when the semiconductor photonics system 100 is assembled.

The lateral (y-direction) width of an alignment groove 136 (indicated in FIG. 4 as dimension D14) may be greater than the lateral (y-direction) width of a corresponding alignment guide 134 (indicated in FIG. 4 as dimension D15) to provide for some amount of lateral (y-direction) adjustment in the alignment of the upper alignment structure 124 and the photonics integrated circuit device 102. The lateral (y-direction) width of an alignment groove 140 (indicated in FIG. 4 as dimension D16) may be greater than the lateral (y-direction) width of a corresponding alignment guide 138 (indicated in FIG. 4 as dimension D17) to provide for some amount of lateral (y-direction) adjustment in the alignment of the optical interconnect structure 108 and the photonics integrated circuit device 102.

The difference between the lateral (y-direction) width of an alignment groove 136 and the lateral (y-direction) width of a corresponding alignment guide 134 (e.g., the difference between dimension D14 and dimension D15) may be greater than the difference between the lateral (y-direction) width of an alignment groove 140 and the lateral (y-direction) width of a corresponding alignment guide 138 (e.g., the difference between dimension D16 and dimension D17) to provide different levels of adjustability in the semiconductor photonics system 100. The greater difference between the lateral (y-direction) width of an alignment groove 136 and the lateral (y-direction) width of a corresponding alignment guide 134 provides for a greater amount of adjustability in the relative positions of the upper alignment structure 124 and the photonics integrated circuit device 102 than the amount of adjustability in the relative positions of the optical interconnect structure 108 and the photonics integrated circuit device 102 provided by the difference between the lateral (y-direction) width of an alignment groove 140 and the lateral (y-direction) width of a corresponding alignment guide 138. Thus, the greater difference between the lateral (y-direction) width of an alignment groove 136 and the lateral (y-direction) width of a corresponding alignment guide 134 provides for coarse adjustment in the optical alignment of the semiconductor photonics system 100, whereas the lesser difference between the lateral (y-direction) width of an alignment groove 140 and the lateral (y-direction) width of a corresponding alignment guide 138 provides for fine adjustment in the optical alignment of the semiconductor photonics system 100.

In some implementations, the difference between the lateral (y-direction) width of an alignment groove 136 and the lateral (y-direction) width of a corresponding alignment guide 134 (e.g., the difference between dimension D14 and dimension D15) may be included in a range of approximately 2% to approximately 7% of the lateral width of the alignment groove 136. In other words, the lateral width of the alignment guide 134 may be approximately 2% to approximately 7% less than the lateral width of the alignment groove 136. However, other values and ranges are within the scope of the present disclosure.

In some implementations, the difference between the lateral (y-direction) width of an alignment groove 140 and the lateral (y-direction) width of a corresponding alignment guide 138 (e.g., the difference between dimension D16 and dimension D17) may be included in a range of approximately 0.2% to approximately 1.8% of the lateral width of the alignment groove 140. In other words, the lateral width of the alignment guide 138 may be approximately 0.2% to approximately 1.8% less than the lateral width of the alignment groove 140. However, other values and ranges are within the scope of the present disclosure.

In some implementations, the lateral (y-direction) width of an alignment guide 134 is included in a range of approximately 50 microns to approximately 2 millimeters. However, other values and ranges are within the scope of the present disclosure. In some implementations, the lateral (y-direction) width of an alignment guide 138 is included in a range of approximately 50 microns to approximately 2 millimeters. However, other values and ranges are within the scope of the present disclosure.

As indicated above, FIG. 4 is provided as an example. Other examples may differ from what is described with regard to FIG. 4.

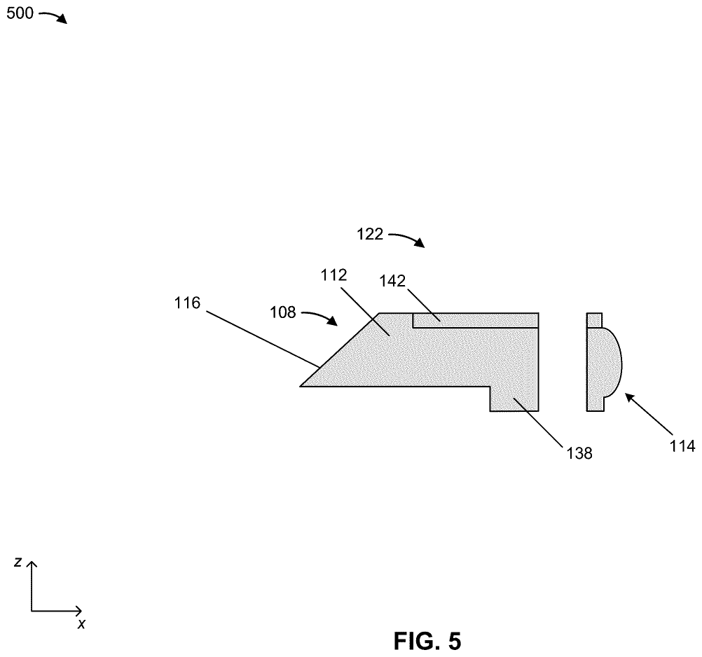

FIG. 5 is a diagram of an example implementation 500 of the optical interconnect structure 108 described herein. The example implementation 500 of the optical interconnect structure 108 is similar to the example implementation of the optical interconnect structure 108 illustrated in FIGS. 1A-1C. However, in the example implementation 500, the microlens structure(s) 114 is removable or detachable from the body 112 of the optical interconnect structure 108. In some implementations, a microlens structure 114 of the optical interconnect structure 108 may be removably secured to the body 112 by clips. In some implementations, a microlens structure 114 of the optical interconnect structure 108 may be removably secured to the body 112 by compression fittings (e.g., press-fit connections). In some implementations, a microlens structure 114 of the optical interconnect structure 108 may be removably secured to the body 112 by another removal attachment mechanism.

The microlens structure(s) 114 being removable or detachable from the body 112 of the optical interconnect structure 108 may facilitate efficient and streamlined maintenance of the optical interconnect structure 108. For example, if a microlens structure 114 is damaged (e.g., during operation or during assembly of the semiconductor photonics system 100), the microlens structure 114 can be removed and replaced instead of scrapping the entire optical interconnect structure 108. Moreover, microlens structure(s) 114 being removable or detachable from the body 112 of the optical interconnect structure 108 may increase the flexibility of the optical interconnect structure 108 to be used in different applications. For example, the microlens structure(s) 114 may be replaced so that the optical interconnect structure 108 can be used for different frequencies of optical signals (e.g., so that the focal length or lens size of the microlens structure(s) 114 can be selected for optimal performance for the frequency of the optical signals).

As indicated above, FIG. 5 is provided as an example. Other examples may differ from what is described with regard to FIG. 5.

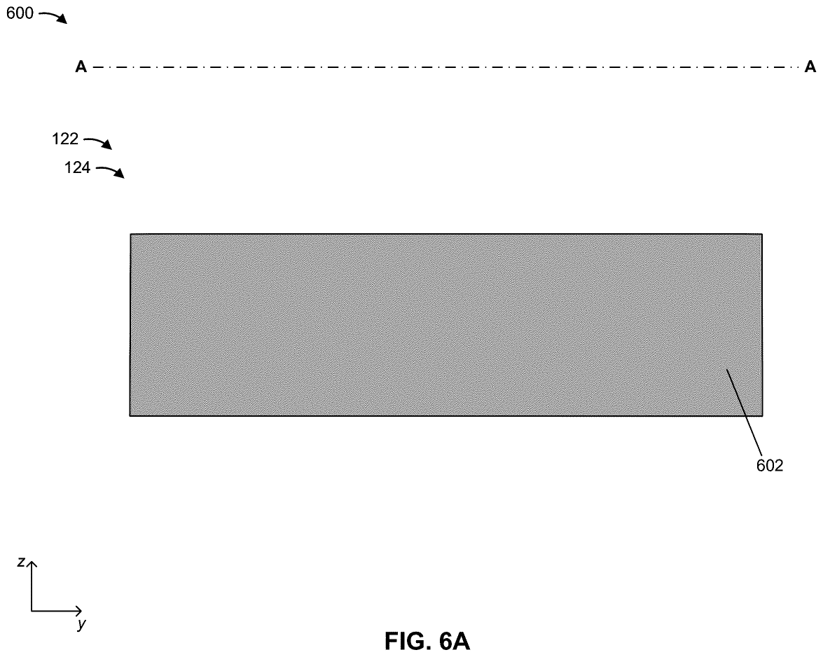

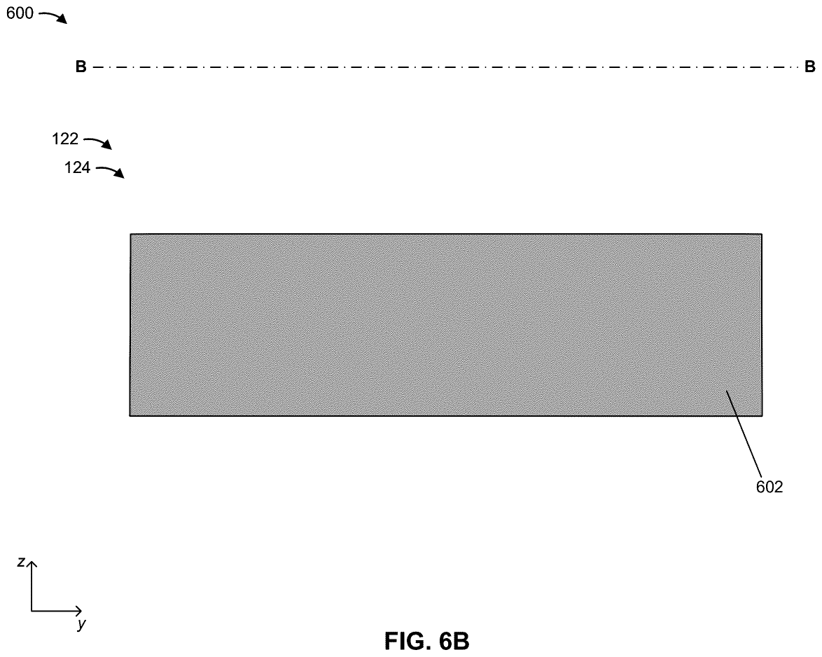

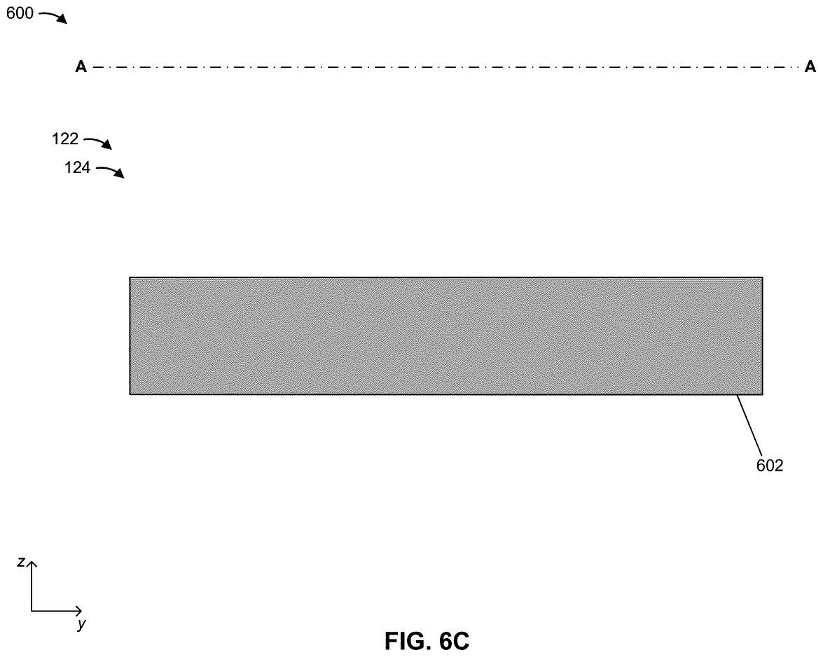

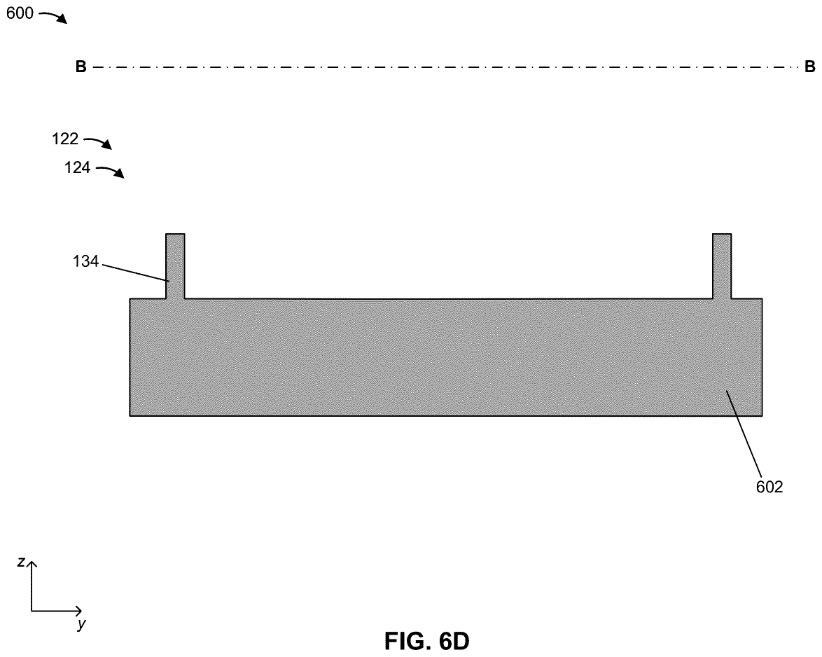

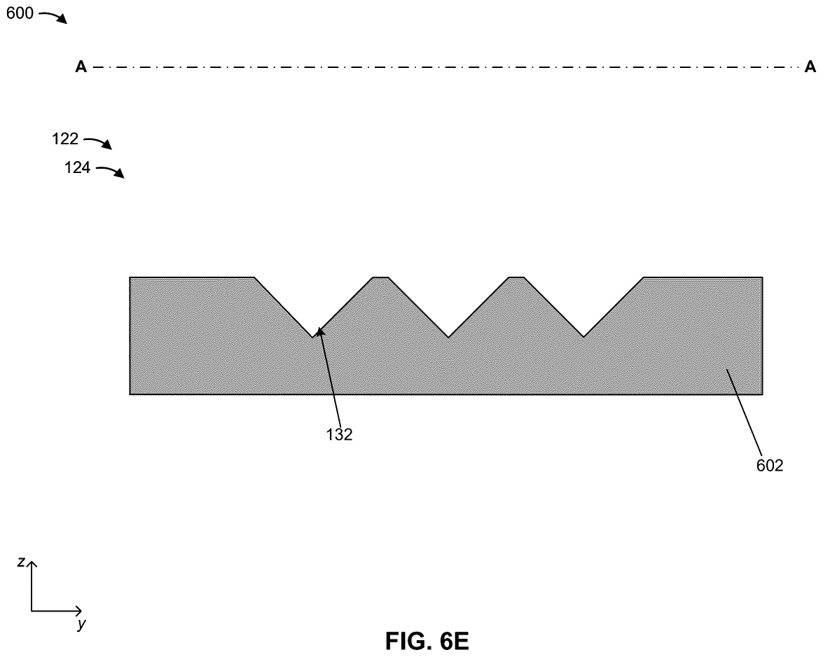

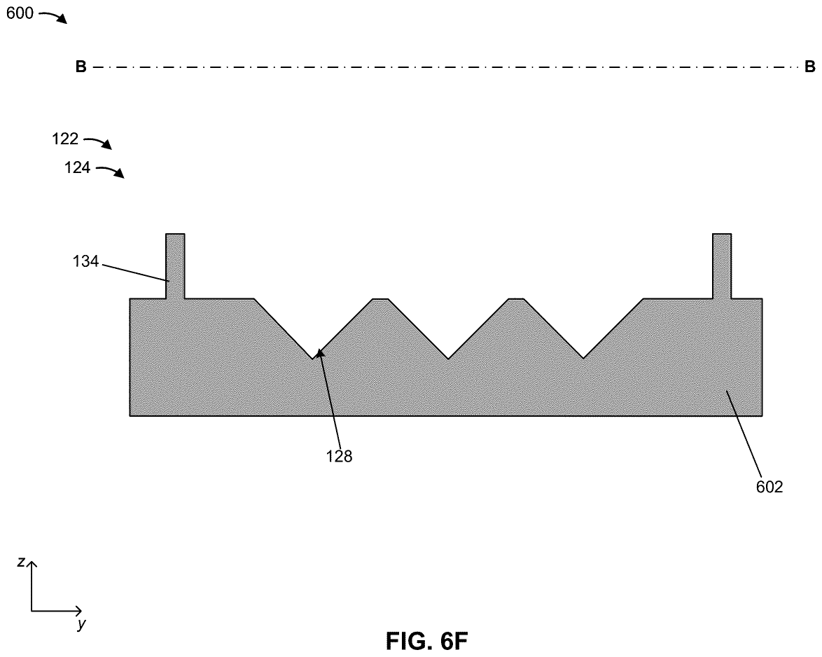

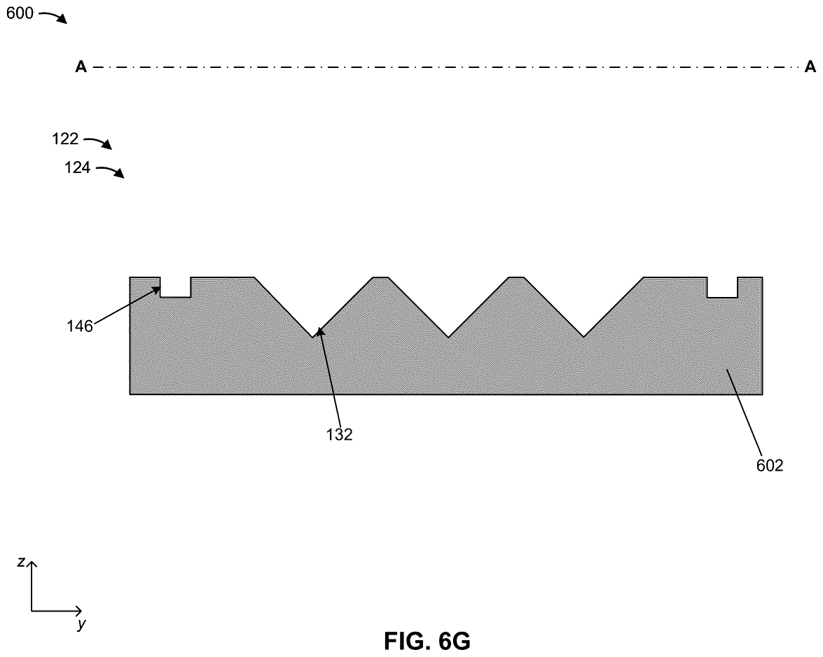

FIGS. 6A-6G are diagrams of an example implementation 600 of forming the upper alignment structure 124 of the photonics alignment device 122 described herein. In some implementations, one or more of the operations described in connection with FIGS. 6A-6G may be performed using one or more semiconductor processing tools, such as a deposition tool, an exposure tool, a developer tool, an etch tool, a planarization tool, a wafer/die transport tool, and/or a pick-and-place tool, among other examples.

As shown in FIGS. 6A and 6B, a substrate 602 may be provided. The substrate 602 may be a portion of a semiconductor wafer (e.g., a silicon wafer), a silicon-on-insulator (SOI) wafer, a dielectric wafer (e.g., a silicon dioxide (SiO₂) wafer), a semiconductor die, a dielectric die, and/or another type of workpiece. A pick-and-place tool or a wafer/die transport tool may provide the substrate 602 to a processing chamber for processing.

As shown in FIGS. 6C and 6D, the substrate 602 may be etched to define the alignment guides 134 of the upper alignment structure 124. In some implementations, a pattern in a photoresist layer is used to etch the substrate 602 to define the alignment guides 134. In these implementations, the pick-and-place tool or the wafer/die transport tool may provide the substrate 602 to a processing chamber of a deposition tool, and the deposition tool may be used to form the photoresist layer on the substrate 602 (e.g., using a spin-coating technique and/or another suitable deposition technique). A pick-and-place tool or a wafer/die transport tool may provide the substrate 602 (with the photoresist layer thereon) to a processing chamber of an exposure tool, and the exposure tool may be used to expose the photoresist layer to a radiation source to pattern the photoresist layer. A pick-and-place tool or a wafer/die transport tool may provide the substrate 602 (with the patterned photoresist layer thereon) to a processing chamber of a developer tool, and the developer tool may be used to develop and remove portions of the photoresist layer to expose the pattern. A pick-and-place tool or a wafer/die transport tool may provide the substrate 602 (with the developed pattern thereon) to a processing chamber of an etch tool, and the etch tool may be used to etch the substrate 602 based on the pattern to define the alignment guides 134. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the substrate 602 based on a pattern.

As shown in FIGS. 6E and 6F, the substrate 602 may be etched to form the alignment grooves 128 and 132 of the upper alignment structure 124. Formation of the alignment grooves 128 and 132 may also define the lateral alignment step 130 of the upper alignment structure 124.

In some implementations, a pattern in a photoresist layer is used to etch the substrate 602 to form the alignment grooves 128 and 132. In these implementations, the pick-and-place tool or the wafer/die transport tool may provide the substrate 602 to a processing chamber of a deposition tool, and the deposition tool may be used to form the photoresist layer on the substrate 602 (e.g., using a spin-coating technique and/or another suitable deposition technique). A pick-and-place tool or a wafer/die transport tool may provide the substrate 602 (with the photoresist layer thereon) to a processing chamber of an exposure tool, and the exposure tool may be used to expose the photoresist layer to a radiation source to pattern the photoresist layer. A pick-and-place tool or a wafer/die transport tool may provide the substrate 602 (with the patterned photoresist layer thereon) to a processing chamber of a developer tool, and the developer tool may be used to develop and remove portions of the photoresist layer to expose the pattern. A pick-and-place tool or a wafer/die transport tool may provide the substrate 602 (with the developed pattern thereon) to a processing chamber of an etch tool, and the etch tool may be used to etch the substrate 602 based on the pattern to form the alignment grooves 128 and 132. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the substrate 602 based on a pattern.

As shown in FIG. 6G, the substrate 602 may be etched to form the alignment grooves 146 of the upper alignment structure 124. In some implementations, a pattern in a photoresist layer is used to etch the substrate 602 to form the alignment grooves 146. In these implementations, the pick-and-place tool or the wafer/die transport tool may provide the substrate 602 to a processing chamber of a deposition tool, and the deposition tool may be used to form the photoresist layer on the substrate 602 (e.g., using a spin-coating technique and/or another suitable deposition technique). A pick-and-place tool or a wafer/die transport tool may provide the substrate 602 (with the photoresist layer thereon) to a processing chamber of an exposure tool, and the exposure tool may be used to expose the photoresist layer to a radiation source to pattern the photoresist layer. A pick-and-place tool or a wafer/die transport tool may provide the substrate 602 (with the patterned photoresist layer thereon) to a processing chamber of a developer tool, and the developer tool may be used to develop and remove portions of the photoresist layer to expose the pattern. A pick-and-place tool or a wafer/die transport tool may provide the substrate 602 (with the developed pattern thereon) to a processing chamber of an etch tool, and the etch tool may be used to etch the substrate 02 based on the pattern to form the alignment grooves 146. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the substrate 602 based on a pattern.

Alternatively, the upper alignment structure 124 may be formed using other manufacturing techniques, such as molding (e.g., injection molding), casting, milling, two-photon polymerization, direct laser writing, and/or extrusion, among other examples. The upper alignment structure 124 can also be made from other material including glass and polymer to facilitate compatibility with other such manufacturing techniques.

As indicated above, FIGS. 6A-6G are provided as an example. Other examples may differ from what is described with regard to FIGS. 6A-6G.

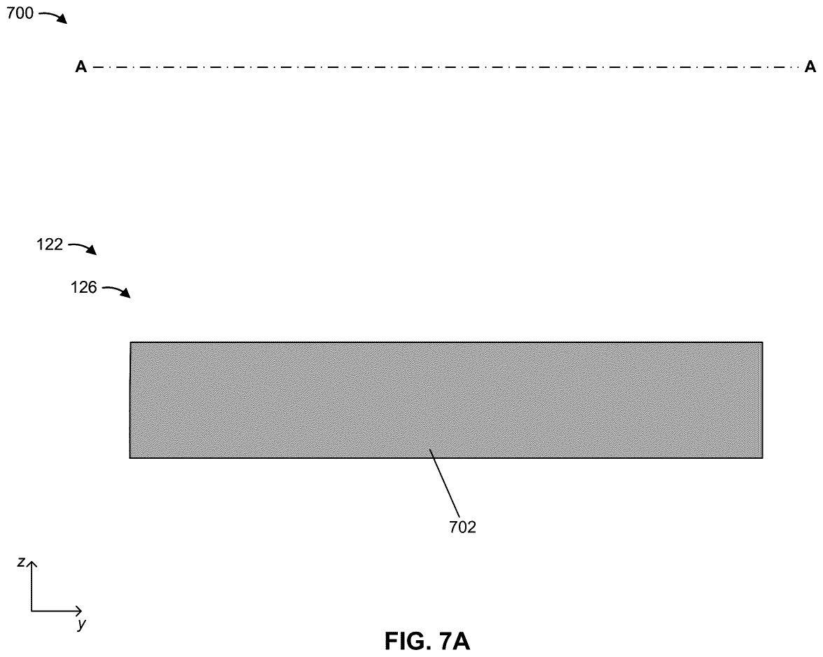

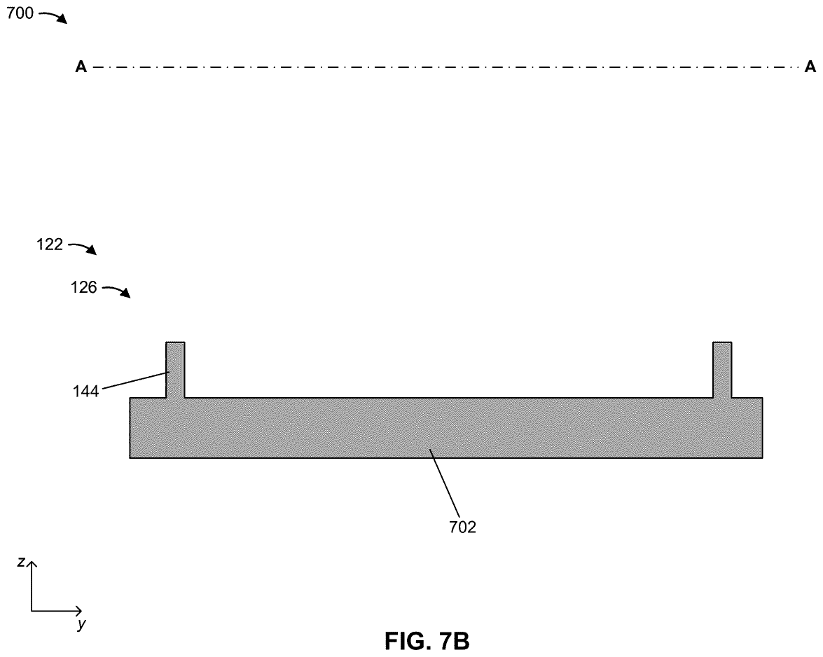

FIGS. 7A and 7B are diagrams of an example implementation 700 of forming the lower alignment structure 126 of the photonics alignment device 122 described herein. In some implementations, one or more of the operations described in connection with FIGS. 7A and 7B may be performed using one or more semiconductor processing tools, such as a deposition tool, an exposure tool, a developer tool, an etch tool, a planarization tool, a wafer/die transport tool, and/or a pick-and-place tool, among other examples.

As shown in FIG. 7A, a substrate 702 may be provided. The substrate 702 may be a portion of a semiconductor wafer (e.g., a silicon wafer), an SOI wafer, a dielectric wafer (e.g., a silicon dioxide (SiO₂) wafer), a semiconductor die, a dielectric die, and/or another type of workpiece. A pick-and-place tool or a wafer/die transport tool may provide the substrate 702 to a processing chamber for processing.

As shown in FIG. 7B, the substrate 702 may be etched to define the alignment guides 144 of the lower alignment structure 126. In some implementations, a pattern in a photoresist layer is used to etch the substrate 702 to define the alignment guides 144. In these implementations, the pick-and-place tool or the wafer/die transport tool may provide the substrate 702 to a processing chamber of a deposition tool, and the deposition tool may be used to form the photoresist layer on the substrate 702 (e.g., using a spin-coating technique and/or another suitable deposition technique). A pick-and-place tool or a wafer/die transport tool may provide the substrate 702 (with the photoresist layer thereon) to a processing chamber of an exposure tool, and the exposure tool may be used to expose the photoresist layer to a radiation source to pattern the photoresist layer. A pick-and-place tool or a wafer/die transport tool may provide the substrate 702 (with the patterned photoresist layer thereon) to a processing chamber of a developer tool, and the developer tool may be used to develop and remove portions of the photoresist layer to expose the pattern. A pick-and-place tool or a wafer/die transport tool may provide the substrate 702 (with the developed pattern thereon) to a processing chamber of an etch tool, and the etch tool may be used to etch the substrate 702 based on the pattern to define the alignment guides 144. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the substrate 702 based on a pattern.

Alternatively, the lower alignment structure 126 may be formed using other manufacturing techniques, such as molding (e.g., injection molding), casting, milling, two-photon polymerization, direct laser writing, and/or extrusion, among other examples. The lower alignment structure 126 can also be made from other material including glass and polymer to facilitate compatibility with other such manufacturing techniques.

As indicated above, FIGS. 7A and 7B are provided as an example. Other examples may differ from what is described with regard to FIGS. 7A and 7B.

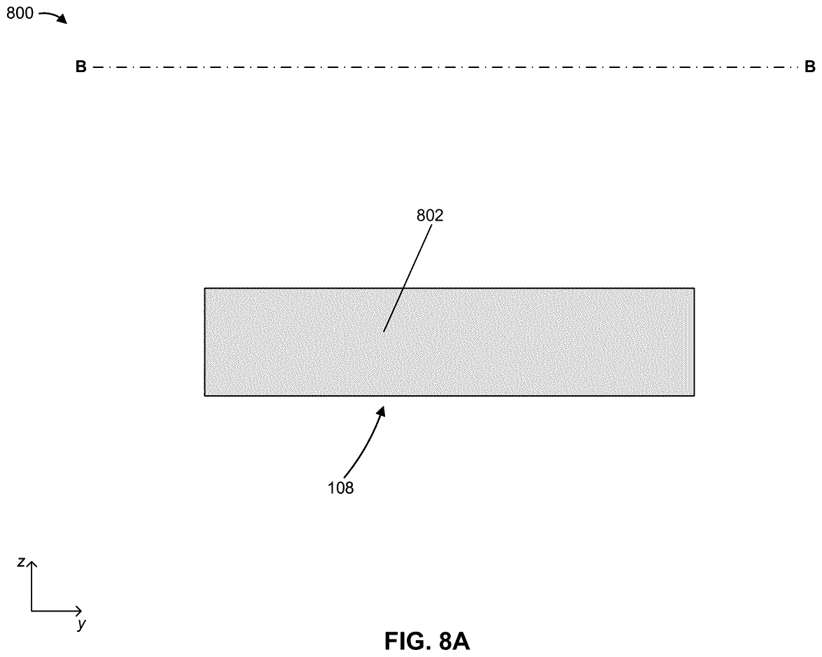

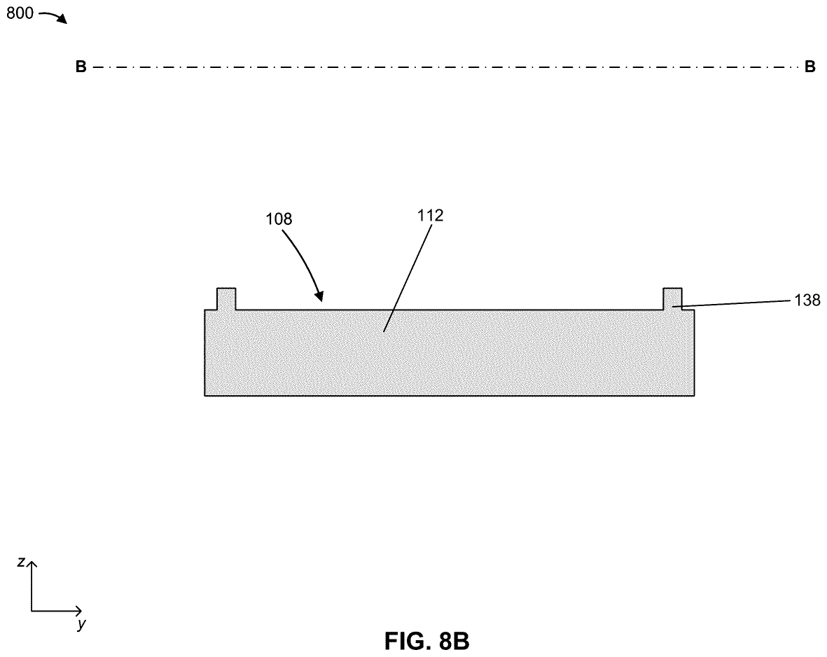

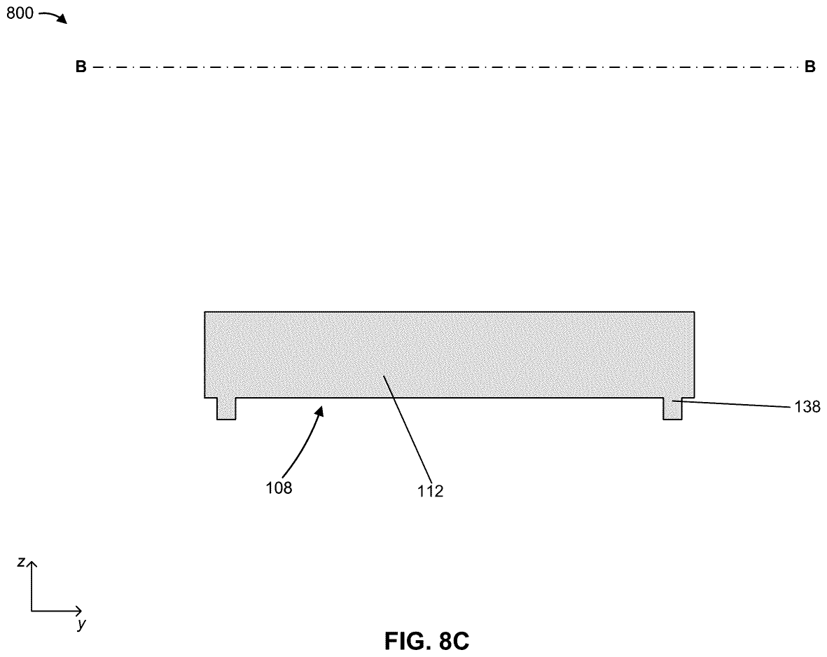

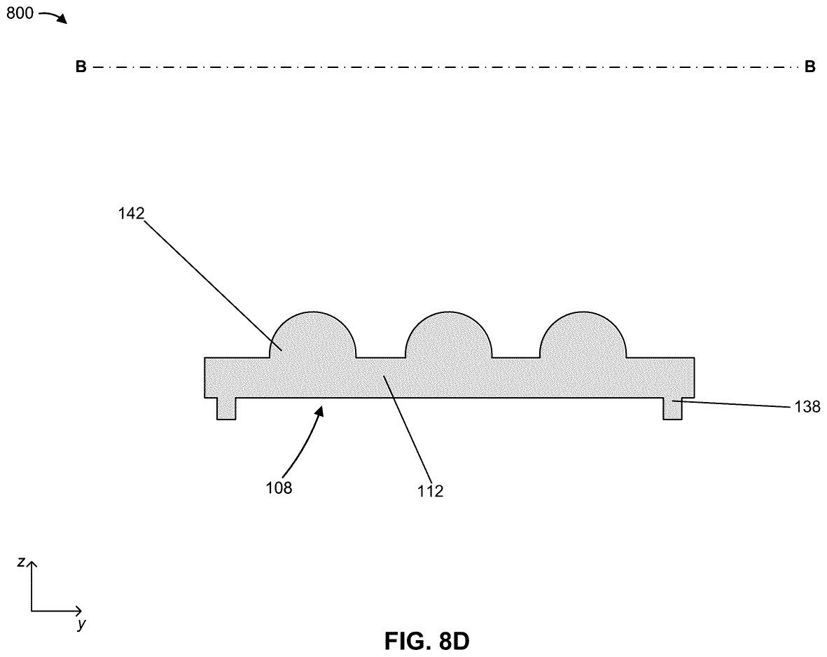

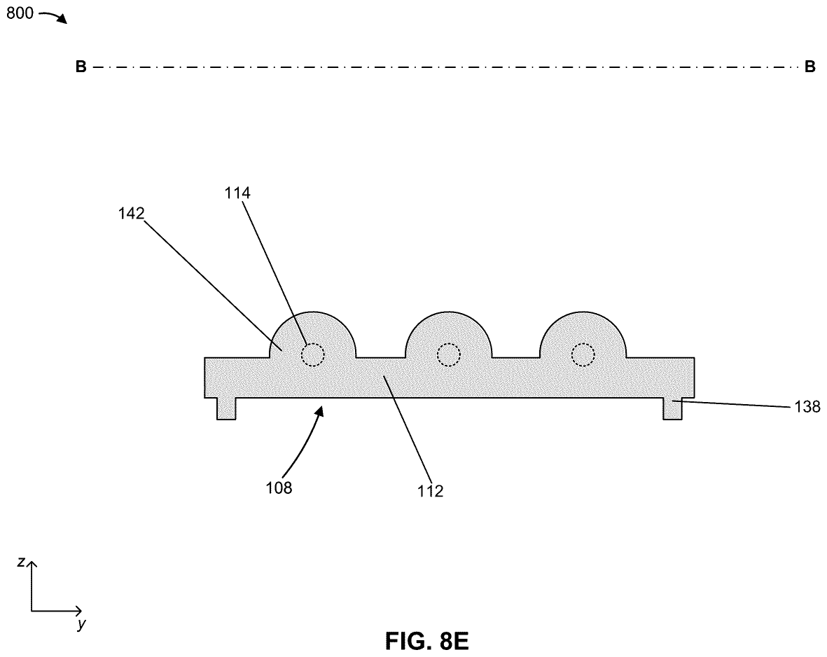

FIGS. 8A-8E are diagrams of an example implementation 800 of forming the optical interconnect structure 108 described herein. In some implementations, one or more of the operations described in connection with FIGS. 8A-8E may be performed using one or more semiconductor processing tools, such as a deposition tool, an exposure tool, a developer tool, an etch tool, a planarization tool, a wafer/die transport tool, and/or a pick-and-place tool, among other examples.

As shown in FIG. 8A, a substrate 802 may be provided. The substrate 802 may be a portion of a semiconductor wafer (e.g., a silicon wafer), an SOI wafer, a dielectric wafer (e.g., a silicon dioxide (SiO₂) wafer), a semiconductor die, a dielectric die, and/or another type of workpiece. A pick-and-place tool or a wafer/die transport tool may provide the substrate 802 to a processing chamber for processing.

As shown in FIG. 8B, the substrate 802 may be etched to define the body 112 and the alignment guides 138 of the optical interconnect structure 108. The substrate 802 may be etched such that the alignment guides 138 extend from a first side (e.g., a bottom side) of the body 112.

In some implementations, a pattern in a photoresist layer is used to etch the substrate 802 to define the body 112 and the alignment guides 138 of the optical interconnect structure 108. In these implementations, the pick-and-place tool or the wafer/die transport tool may provide the substrate 802 to a processing chamber of a deposition tool, and the deposition tool may be used to form the photoresist layer on the substrate 802 (e.g., using a spin-coating technique and/or another suitable deposition technique). A pick-and-place tool or a wafer/die transport tool may provide the substrate 802 (with the photoresist layer thereon) to a processing chamber of an exposure tool, and the exposure tool may be used to expose the photoresist layer to a radiation source to pattern the photoresist layer. A pick-and-place tool or a wafer/die transport tool may provide the substrate 802 (with the patterned photoresist layer thereon) to a processing chamber of a developer tool, and the developer tool may be used to develop and remove portions of the photoresist layer to expose the pattern. A pick-and-place tool or a wafer/die transport tool may provide the substrate 802 (with the developed pattern thereon) to a processing chamber of an etch tool, and the etch tool may be used to etch the substrate 02 based on the pattern to define the body 112 and the alignment guides 138 of the optical interconnect structure 108. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the substrate 802 based on a pattern.

As shown in FIG. 8C, a pick-and-place tool or a wafer/die transport tool may be used to flip the optical interconnect structure 108 so that a second side (e.g., a top side) vertically opposite the first side may be processed.

As shown in FIG. 8D, the body 112 of the optical interconnect structure 108 may be etched to define the alignment guides 142 of the optical interconnect structure 108. The body 112 may be etched such that the alignment guides 142 extend from the second side (e.g., the top side) of the body 112.

In some implementations, a pattern in a photoresist layer is used to etch the body 112 of the optical interconnect structure 108 to define the alignment guides 142. In these implementations, the pick-and-place tool or the wafer/die transport tool may provide the optical interconnect structure 108 to a processing chamber of a deposition tool, and the deposition tool may be used to form the photoresist layer on the body 112 of the optical interconnect structure 108 (e.g., using a spin-coating technique and/or another suitable deposition technique). A pick-and-place tool or a wafer/die transport tool may provide the optical interconnect structure 108 (with the photoresist layer thereon) to a processing chamber of an exposure tool, and the exposure tool may be used to expose the photoresist layer to a radiation source to pattern the photoresist layer. A pick-and-place tool or a wafer/die transport tool may provide the optical interconnect structure 108 (with the patterned photoresist layer thereon) to a processing chamber of a developer tool, and the developer tool may be used to develop and remove portions of the photoresist layer to expose the pattern. A pick-and-place tool or a wafer/die transport tool may provide the optical interconnect structure 108 (with the developed pattern thereon) to a processing chamber of an etch tool, and the etch tool may be used to etch the body 112 of the optical interconnect structure 108 based on the pattern to define the alignment guides 142. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the body 112 of the optical interconnect structure 108 based on a pattern.

As shown in FIG. 8E, the microlens structures 114 of the optical interconnect structure 108 may be formed. In some implementations, forming the microlens structures 114 includes etching the body 112 of the optical interconnect structure 108 to define the microlens structures 114. In some implementations, forming the microlens structures 114 includes attaching the microlens structures 114 to the body 112 of the optical interconnect structure 108.

Alternatively, the optical interconnect structure 108 may be formed using other manufacturing techniques, such as molding (e.g., injection molding), casting, milling, two-photon polymerization, direct laser writing, and/or extrusion, among other examples. The optical interconnect structure 108 can also be made from other material including glass and polymer to facilitate compatibility with other such manufacturing techniques.

As indicated above, FIGS. 8A-8E are provided as an example. Other examples may differ from what is described with regard to FIGS. 8A-8E.

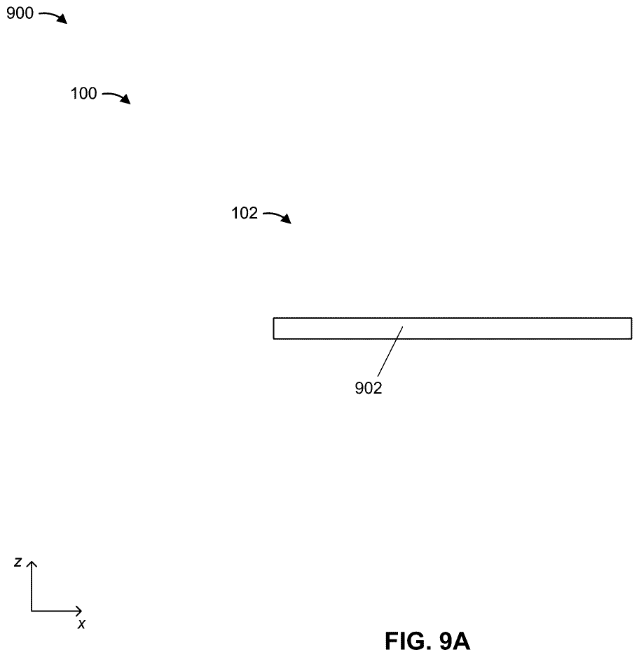

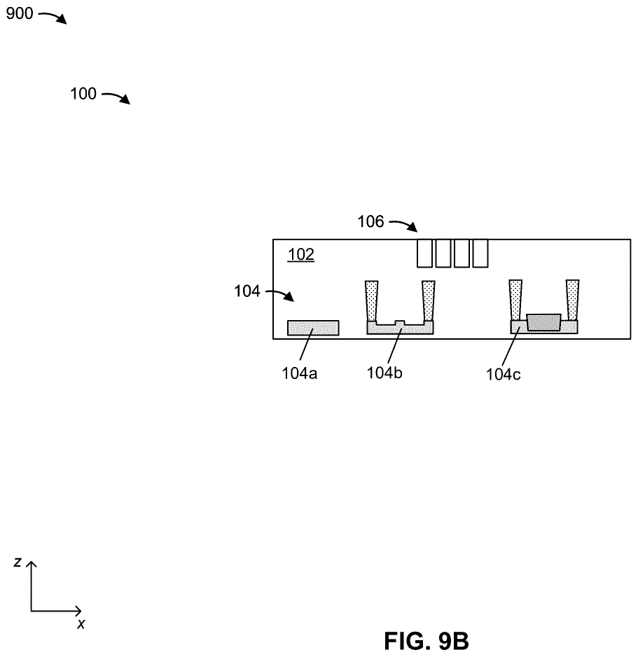

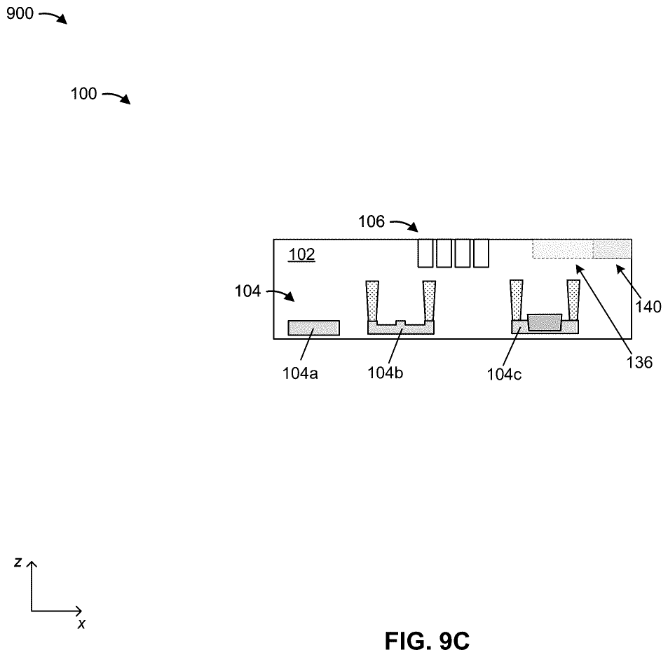

FIGS. 9A-9C are diagrams of an example implementation 900 of forming the photonic integrated circuit device 102 of the semiconductor photonics system 100 described herein. In some implementations, one or more of the operations described in connection with FIGS. 9A-9C may be performed using one or more semiconductor processing tools, such as a deposition tool, an exposure tool, a developer tool, an etch tool, an ion implantation tool, a planarization tool, a bonding tool, a wafer/die transport tool, and/or a pick-and-place tool, among other examples.

As shown in FIG. 9A, a substrate 902 may be provided. The substrate 902 may be a portion of a semiconductor wafer (e.g., a silicon wafer), an SOI wafer, a dielectric wafer (e.g., a silicon dioxide (SiO₂) wafer), a semiconductor die, a dielectric die, and/or another type of workpiece. A pick-and-place tool or a wafer/die transport tool may provide the substrate 902 to a processing chamber for processing.

As shown in FIG. 9B, photonics components of a photonic integrated circuit 104 may be formed in and/or on the substrate 902. In some implementations, forming a photonics component of the photonic integrated circuit 104 may include etching a semiconductor layer of the substrate 902 to define an optical waveguide 104a. In some implementations, forming a photonics component of the photonic integrated circuit 104 may include depositing a dielectric layer above the substrate 902 and etching the dielectric layer to define an optical waveguide 104a. In some implementations, forming a photonics component of the photonic integrated circuit 104 may include etching a semiconductor layer of the substrate 902 to define a waveguide portion of an optical modulator 104b, and forming contacts above the waveguide portion. In some implementations, forming a photonics component of the photonic integrated circuit 104 may include etching a semiconductor layer of the substrate 902 to define a semiconductor base of a photodetector 104c, forming a semiconductor sensing region (e.g., a germanium (Ge) sensing region) on the semiconductor base, and forming contacts above the semiconductor base.

As further shown in FIG. 9B, a grating coupler 106 may be formed in the photonic integrated circuit device 102. Forming the grating coupler 106 may include depositing a layer of material and etching the layer of material to define a plurality of gratings of the grating coupler 106. In some implementations, electrical integrated circuits are also formed in the photonic integrated circuit device 102.

As shown in FIG. 9C, the alignment grooves 136 and 140 may be formed in the photonic integrated circuit device 102. In some implementations, forming the alignment grooves 136 and 140 may include depositing a layer of dielectric material and etching the layer of dielectric material to form the alignment grooves 136 and 140.

A deposition tool may be used to deposit the layer of dielectric material using a physical vapor deposition (PVD) technique, an atomic layer deposition (ALD) technique, a chemical vapor deposition (CVD) technique, an oxidation technique, and/or another suitable deposition technique. In some implementations, a planarization tool may be used to perform a planarization operation (e.g., a chemical-mechanical planarization (CMP) operation) to planarize the layer of dielectric material after the layer of dielectric material is deposited.

In some implementations, a pattern in a photoresist layer is used to etch the layer of dielectric material to form the alignment grooves 136 and 140. In these implementations, a deposition tool may be used to form the photoresist layer on the layer of dielectric material (e.g., using a spin-coating technique and/or another suitable deposition technique). An exposure tool may be used to expose the photoresist layer to a radiation source to pattern the photoresist layer. A developer tool may be used to develop and remove portions of the photoresist layer to expose the pattern. An etch tool may be used to etch the layer of dielectric material based on the pattern to form the alignment grooves 136 and 140. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the layer of dielectric material based on a pattern.

As indicated above, FIGS. 9A-9C are provided as an example. Other examples may differ from what is described with regard to FIGS. 9A-9C.

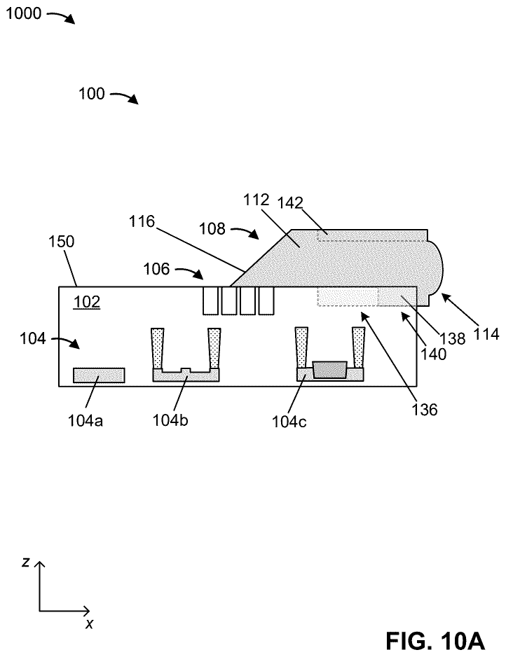

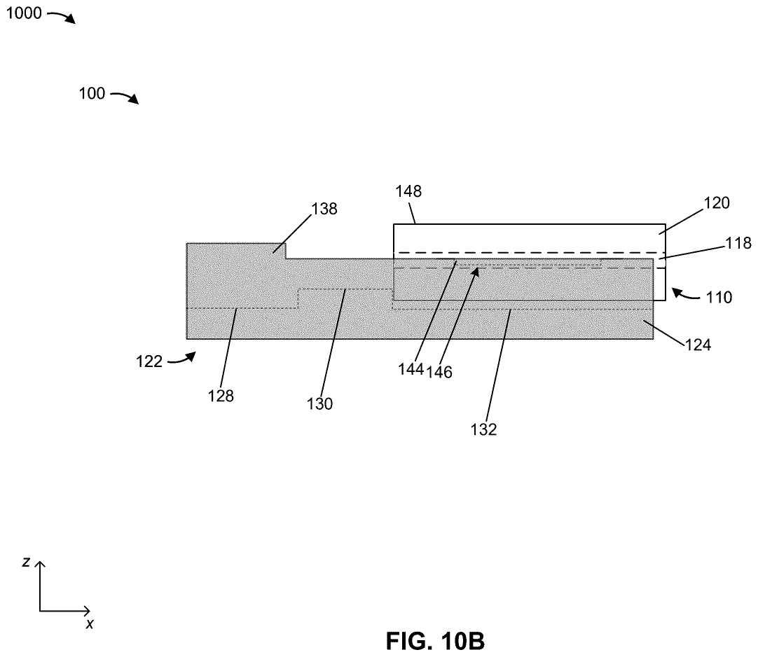

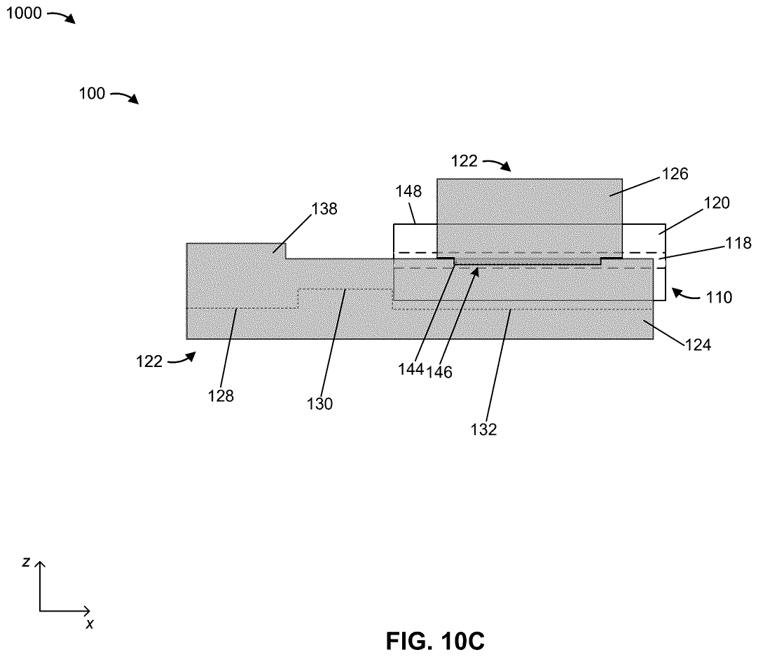

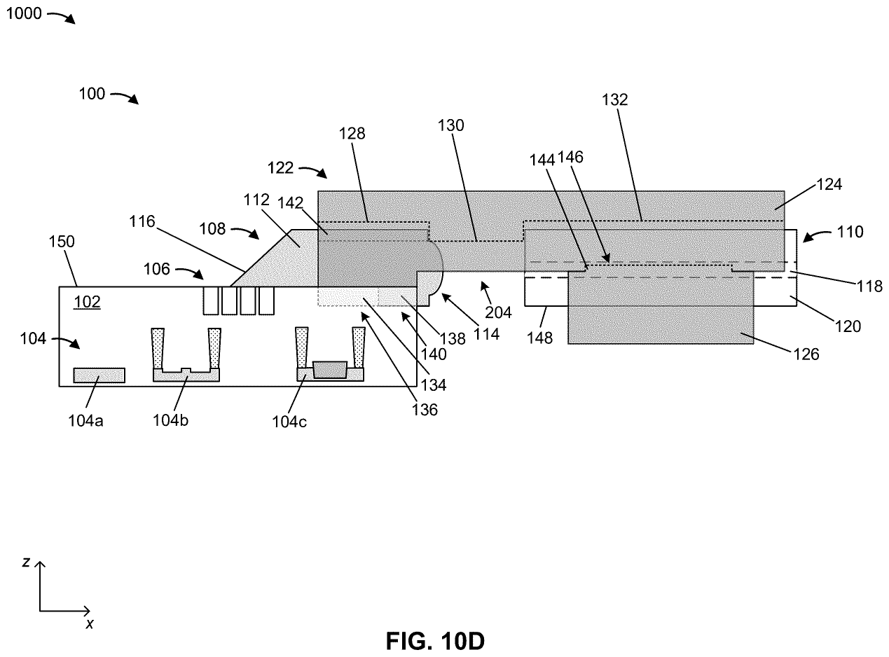

FIGS. 10A-10D are diagrams of an example implementation 1000 of assembling the semiconductor photonics system 100 described herein. In some implementations, one or more of the operations described in connection with FIGS. 10A-10D may be performed using one or more semiconductor processing tools, such as a deposition tool, an exposure tool, a developer tool, an etch tool, a planarization tool, a wafer/die transport tool, and/or a pick-and-place tool, among other examples.

As shown in FIG. 10A, a photonic integrated circuit device 102 may be provided. A pick-and-place tool or a wafer/die transport tool may provide the photonic integrated circuit device 102 onto a support member such as a fixture. In some implementations, the photonic integrated circuit device 102 is provided onto a printed circuit board (PCB). In these implementations, the photonic integrated circuit device 102 may be soldered to the PCB or placed in a socket on the photonic integrated circuit device 102, among other examples.

As further shown in FIG. 10A, an optical interconnect structure 108 may be provided above and/or on the photonic integrated circuit device 102. For example, a pick-and-place tool or a wafer/die transport tool may position the optical interconnect structure 108 on the photonic integrated circuit device 102 such that a portion of the optical interconnect structure 108 is located over a portion of the grating coupler 106, and such that the alignment guides 138 of the optical interconnect structure 108 are positioned in the alignment grooves 140 in the top surface 150 of the photonic integrated circuit device 102.

As shown in FIG. 10B, an upper alignment structure 124 of a photonics alignment device 122 may be provided. A pick-and-place tool or a wafer/die transport tool may provide the upper alignment structure 124 upside down onto a support member such as a fixture.

As further shown in FIG. 10B, an optical fiber 110 (or a plurality of optical fibers 110) may be provided. A pick-and-place tool or a wafer/die transport tool may provide the optical fiber 110 onto the upper alignment structure 124 such that the optical fiber 110 is supported in an alignment groove 146 of the upper alignment structure 124. The fiber core 118 and the cladding 120 of the optical fiber 110 may be positioned in the alignment groove 132 of the upper alignment structure 124. In other words, the optical fiber 110 may be positioned in the alignment groove 132 of the upper alignment structure 124 without stripping or removing the cladding 120 from a portion of the fiber core 118 that is to face the microlens structure 114 of the optical interconnect structure 108.

As shown in FIG. 10C, a lower alignment structure 126 of the photonics alignment device 122 may be provided. A pick-and-place tool or a wafer/die transport tool may provide the lower alignment structure 126 onto the optical fiber 110 and onto the upper alignment structure 124 so that the optical fiber is secured in the alignment groove 132. The alignment guides 144 on the lower alignment structure 126 are inserted into the alignment grooves 146 in the upper alignment structure 124. The alignment groove 132 is fitted around the optical fiber 110 (e.g., the fiber core 118 and the cladding 120 of the optical fiber 110) so that the optical fiber 110 is secured in the alignment groove 132 between the upper alignment structure 124 and the lower alignment structure 126. The combination of the alignment groove 132, the alignment guides 144, and the alignment grooves 146 define the position of the optical fiber 110 in the x-direction (e.g., in the direction of propagation of optical signals between the optical fiber 110 and the optical interconnect structure 108), as well as in the y-direction and z-direction (e.g., in directions approximately perpendicular to the propagation of the optical signals) for alignment with the microlens structure 114.

As shown in FIG. 10D, the photonics alignment device 122 and the optical fiber 110 are flipped and positioned relative to the photonics integrated circuit device 102 and the optical interconnect structure 108. The alignment guides 134 on the upper alignment structure 124 are inserted into the alignment grooves 136 in top surface 150 of the photonic integrated circuit device 102. The alignment groove 128 in the upper alignment structure 124 is fitted around the alignment guide 142 at the top of the optical interconnect structure 108 so that the optical interconnect structure 108 is secured in the alignment groove 128 between the upper alignment structure 124 and the photonic integrated circuit device 102.

The combination of the alignment groove 128, the alignment guides 134, the alignment grooves 136, the alignment guides 138, the alignment grooves 140, and the alignment guide 142 define the position of the optical interconnect structure 108 in the y-direction and z-direction (e.g., in directions approximately perpendicular to the propagation of the optical signals) for alignment of the microlens structure 114 and the end of the fiber core 118 facing the microlens structure 114.

The lateral alignment step 130 of the upper alignment structure 124 positions the optical fiber 110 and the microlens structure 114 such that the end of the fiber core 118 facing the microlens structure 114 is spaced apart from the microlens structure 114 by an airgap 204. The lateral alignment step 130 of the upper alignment structure 124 defines the length of the airgap 204 laterally between the microlens structure 114 and the end of the fiber core 118 of the optical fiber 110 facing the microlens structure 114.

As indicated above, FIGS. 10A-10D are provided as an example. Other examples may differ from what is described with regard to FIGS. 10A-10D.

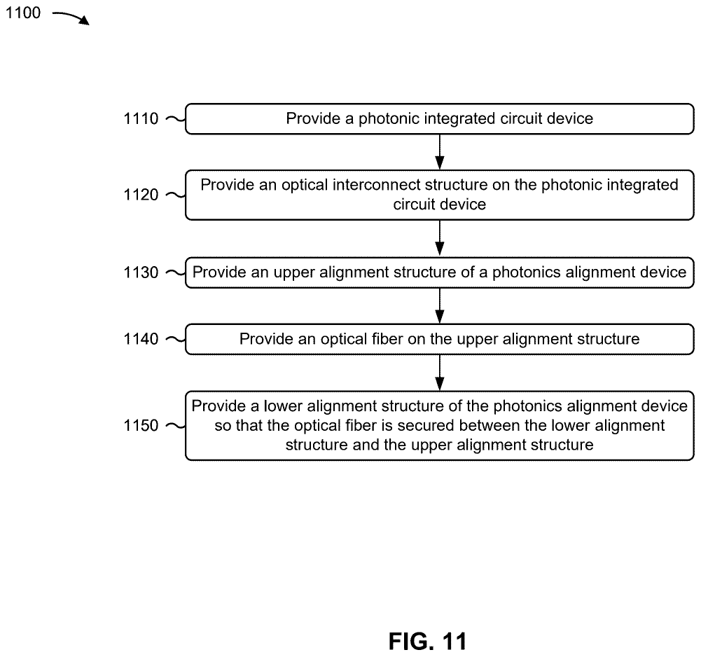

FIG. 11 is a flowchart of an example process 1100 associated with forming a semiconductor photonics system. In some implementations, one or more process blocks of FIG. 11 are performed using one or more semiconductor processing tools, such as a pick-and-place tool, a deposition tool, an exposure tool, a developer tool, an etch tool, a planarization tool, an ion implantation tool, an annealing tool, a wafer/die transport tool, and/or another type of semiconductor processing tool.

As shown in FIG. 11, process 1100 may include providing a photonic integrated circuit device (block 1110). For example, one or more semiconductor processing tools may be used to provide a photonic integrated circuit device 102, as described herein. In some implementations, the photonic integrated circuit device 102 includes a photonic integrated circuit 104 and a grating coupler 106.

As further shown in FIG. 11, process 1100 may include providing an optical interconnect structure on the photonic integrated circuit device (block 1120). For example, one or more semiconductor processing tools may be used to provide an optical interconnect structure 108 on the photonic integrated circuit device 102, as described herein. In some implementations, first alignment guides 138 of the optical interconnect structure 108 are interfaced with first alignment grooves 140 on the photonic integrated circuit device 102 so that the optical interconnect structure 108 is over at least a portion of the grating coupler 106.

As further shown in FIG. 11, process 1100 may include providing an upper alignment structure of a photonics alignment device (block 1130). For example, one or more semiconductor processing tools may be used to provide an upper alignment structure 124 of a photonics alignment device 122, as described herein.

As further shown in FIG. 11, process 1100 may include providing an optical fiber on the upper alignment structure (block 1140). For example, one or more semiconductor processing tools may be used to provide an optical fiber 110 on the upper alignment structure 124, as described herein.

As further shown in FIG. 11, process 1100 may include providing a lower alignment structure of the photonics alignment device so that the optical fiber is secured between the lower alignment structure and the upper alignment structure (block 1150). For example, one or more semiconductor processing tools may be used to provide a lower alignment structure 126 of the photonics alignment device 122 so that the optical fiber 110 is secured between the lower alignment structure 126 and the upper alignment structure 124, as described herein. In some implementations, the upper alignment structure 124 secures the optical interconnect structure 108 between the photonic integrated circuit device 102 and the upper alignment structure 124. In some implementations, second alignment guides 134 of the upper alignment structure 124 are interfaced with second alignment grooves 136 on the photonic integrated circuit device 102.

Process 1100 may include additional implementations, such as any single implementation or any combination of implementations described below and/or in connection with one or more other processes described elsewhere herein.

In a first implementation, process 1100 includes forming the first alignment grooves 140 in a top surface 150 of the photonic integrated circuit device 102, and forming the alignment grooves 136 in the top surface 150 of the photonic integrated circuit device 102.

In a second implementation, alone or in combination with the first implementation, providing the upper alignment structure 124 includes positioning a lateral alignment step 130 of the upper alignment structure 124 laterally between the optical interconnect structure 108 and the optical fiber 110 so that the lateral alignment step 130 defines a fixed-length airgap 204 between the optical interconnect structure 108 and the optical fiber 110.

In a third implementation, alone or in combination with one or more of the first and second implementations, third alignment guides 144 of the lower alignment structure 126 are interfaced with third alignment grooves 146 on the upper alignment structure 124.

In a fourth implementation, alone or in combination with one or more of the first through third implementations, fourth alignment guides 144 of the optical interconnect structure 108 are interfaced with fourth alignment grooves 128 on the upper alignment structure 124.

Although FIG. 11 shows example blocks of process 1100, in some implementations, process 1100 includes additional blocks, fewer blocks, different blocks, or differently arranged blocks than those depicted in FIG. 11. Additionally, or alternatively, two or more of the blocks of process 1100 may be performed in parallel.

In this way, a photonic alignment device, for use in a semiconductor photonics system, may include a combination of alignment grooves and alignment guides to provide a highly reliable and repeatable mechanism for aligning a photonic integrated circuit device, an optical interconnect structure, and an optical fiber. The photonics alignment device may increase manufacturing throughput of semiconductor photonics systems in that the photonics alignment device enables alignment of the optical fiber and optical interconnect structure to be achieved in an expedient matter without having to strip the cladding from around the end of the fiber core for optically coupling the optical fiber to the optical interconnect structure (which eliminates a time-consuming processing operation in the manufacturing of semiconductor photonics systems).

As described in greater detail above, some implementations described herein provide a photonics alignment device. The photonics alignment device includes a lower alignment structure. The photonics alignment device includes an upper alignment structure, configured to be removably coupled to the lower alignment structure, comprising, a first alignment groove configured to secure an optical fiber between the upper alignment structure and the lower alignment structure a second alignment groove configured to secure an optical interconnect structure between the upper alignment structure and a photonic integrated circuit device.

As described in greater detail above, some implementations described herein provide a photonics system. The photonics system includes a photonic integrated circuit device. The photonics system includes an optical interconnect structure optically coupled to the photonic integrated circuit device. The photonics system includes an optical fiber optically coupled to the optical interconnect structure. The photonics system includes a photonics alignment device coupled to the photonic integrated circuit device, the optical interconnect structure, and the optical fiber, where the optical interconnect structure and the optical fiber are spaced apart by an airgap.

As described in greater detail above, some implementations described herein provide a method. The method includes providing a photonic integrated circuit device, where the photonic integrated circuit device includes a photonic integrated circuit and a grating coupler. The method includes providing an optical interconnect structure on the photonic integrated circuit device, where first alignment guides of the optical interconnect structure are interfaced with first alignment grooves on the photonic integrated circuit device so that the optical interconnect structure is over at least a portion of the grating coupler. The method includes providing an upper alignment structure of a photonics alignment device. The method includes providing an optical fiber on the upper alignment structure. The method includes providing a lower alignment structure of the photonics alignment device so that the optical fiber is secured between the lower alignment structure and the upper alignment structure, where the upper alignment structure secures the optical interconnect structure between the photonic integrated circuit device and the upper alignment structure, and where second alignment guides of the upper alignment structure are interfaced with second alignment grooves on the photonic integrated circuit device.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonics alignment device, comprising:
a lower alignment structure; and
an upper alignment structure, configured to be removably coupled to the lower alignment structure, comprising:
a first alignment groove configured to secure an optical fiber between the upper alignment structure and the lower alignment structure; and
a second alignment groove configured to secure an optical interconnect structure between the upper alignment structure and a photonic integrated circuit device.

2. The photonics alignment device of claim 1, wherein the first alignment groove is located at a first end of the upper alignment structure;
wherein the second alignment groove is located at a second end of the alignment structure opposing the first end; and
wherein the first alignment groove and the second alignment groove are approximately aligned in a direction along a length of the upper alignment structure.

3. The photonics alignment device of claim 2, wherein the first alignment groove and the second alignment groove are spaced apart in the direction along the length of the upper alignment structure.

4. The photonics alignment device of claim 3, wherein the upper alignment structure comprises a lateral alignment step laterally between the first alignment groove and the second alignment groove in the direction along the length of the upper alignment structure.

5. The photonics alignment device of claim 1, wherein a width of the first alignment groove is sized to receive a fiber core of the optical fiber and a cladding of the optical fiber.

6. The photonics alignment device of claim 1, wherein the lower alignment structure comprises a first set of alignment guides that are configured to interface with third alignment grooves of the upper alignment structure; and
wherein the upper alignment structure comprises a second set of alignment guides that are configured to interface with fourth alignment grooves of the photonic integrated circuit device.

7. The photonics alignment device of claim 6, wherein the first set of alignment guides are located on opposing sides of the first alignment groove; and
wherein the second set of alignment guides are located on opposing sides of the second alignment groove.

8. A photonics system, comprising:
a photonic integrated circuit device;
an optical interconnect structure optically coupled to the photonic integrated circuit device;
an optical fiber optically coupled to the optical interconnect structure; and
a photonics alignment device coupled to the photonic integrated circuit device, the optical interconnect structure, and the optical fiber,
wherein the optical interconnect structure and the optical fiber are spaced apart by an airgap.

9. The photonics system of claim 8, wherein the optical interconnect structure comprises a microlens structure facing the optical fiber.

10. The photonics system of claim 9, wherein the microlens structure is removable from a body of the optical interconnect structure.

11. The photonics system of claim 8, wherein the photonics alignment device comprises a lateral alignment step laterally between the optical interconnect structure and the optical fiber,
wherein the lateral alignment step spans across the airgap.

12. The photonics system of claim 8, wherein the photonics alignment device comprises a first set of alignment guides that are configured to interface with first alignment grooves of the photonic integrated circuit device; and
wherein the optical interconnect structure comprises a second set of alignment guides that are configured to interface with second alignment grooves of the photonic integrated circuit device.

13. The photonics system of claim 12, wherein the first set of alignment guides extend alongside opposing sides of the optical interconnect structure.

14. The photonics system of claim 12, wherein widths of the first alignment grooves a greater than widths of the second alignment grooves.

15. The photonics system of claim 8, wherein the optical interconnect structure comprises an alignment guide that interfaces with an alignment groove of the photonics alignment device.

16. A method, comprising:
providing a photonic integrated circuit device,
wherein the photonic integrated circuit device comprises a photonic integrated circuit and a grating coupler;
providing an optical interconnect structure on the photonic integrated circuit device,
wherein first alignment guides of the optical interconnect structure are interfaced with first alignment grooves on the photonic integrated circuit device so that the optical interconnect structure is over at least a portion of the grating coupler;
providing an upper alignment structure of a photonics alignment device;
providing an optical fiber on the upper alignment structure; and
providing a lower alignment structure of the photonics alignment device so that the optical fiber is secured between the lower alignment structure and the upper alignment structure,
wherein the upper alignment structure secures the optical interconnect structure between the photonic integrated circuit device and the upper alignment structure, and
wherein second alignment guides of the upper alignment structure are interfaced with second alignment grooves on the photonic integrated circuit device.

17. The method of claim 16, further comprising:
forming the first alignment grooves in a top surface of the photonic integrated circuit device; and
forming the second alignment grooves in the top surface of the photonic integrated circuit device.

18. The method of claim 16, wherein providing the upper alignment structure comprises:
positioning a lateral alignment step of the upper alignment structure laterally between the optical interconnect structure and the optical fiber so that the lateral alignment step defines a fixed-length airgap between the optical interconnect structure and the optical fiber.

19. The method of claim 16, wherein third alignment guides of the lower alignment structure are interfaced with third alignment grooves on the upper alignment structure.

20. The method of claim 19, wherein fourth alignment guides of the optical interconnect structure are interfaced with fourth alignment grooves on the upper alignment structure.
